(19) United States
(12) Patent Application Publication
(10) Pub. No.: US 2026/0079420 A1
(43) Pub. Date: Mar. 19, 2026

(54) IMAGE FORMING APPARATUS

(71) Applicant: CANON KABUSHIKI KAISHA, Tokyo (JP)

(72) Inventor: Noritomo Yamaguchi, Kanagawa (JP)

(21) Appl. No.: 19/322,918

(22) Filed: Sep. 9, 2025

(30) Foreign Application Priority Data
Sep. 13, 2024 (JP) 2024-159537

(51) Int. Cl. G03G 15/01; G03G 15/00; G03G 15/08

(52) U.S. Cl. CPC G03G 15/0121; G03G 15/0194; G03G 15/0875; G03G 15/0879; G03G 15/0886; G03G 15/0891; G03G 15/50

(57) ABSTRACT

An image forming apparatus includes a first cartridge, a second cartridge, and an apparatus body include a pump portion, a first developer container, a second developer container, a first tube, and a second tube. A portion, of the first tube, which is longer than half a length from the first end to the second end is configured to extend in a horizontal direction, a downwardly inclined direction, or an upwardly inclined direction at an angle of 45 degrees or less with respect to the horizontal direction. The length from the first end to the second end of the first tube is longer than the length from the third end to the fourth end of the second tube. A cross-sectional area of an interior space of the first tube is larger than a cross-sectional area of an interior space of the second tube.

### BACKGROUND

### Field of the Technology

The present disclosure relates to image forming apparatuses that convey toner together with air.

### Description of the Related Art

In general, image forming apparatuses that adopt an electrophotographic system form images by transferring toner images formed on a surface of a photosensitive drum onto a transfer material serving as a transfer medium. Known methods related to replenishing developer include a process cartridge system and a toner replenishing system. The process cartridge system relates to a system in which the photosensitive drum and a developer container are integrated as a process cartridge, and when developer runs out, the process cartridge is replaced with a new cartridge.

Meanwhile, the toner replenishing system is a system in which new toner is replenished to the developing container when toner runs out. Hitherto, an image forming apparatus that includes a powder supplying device including a powder accommodating portion for accommodating toner and capable of supplying toner to a toner hopper disposed on the image forming apparatus body has been proposed (refer to Japanese Patent Application Laid-Open Publication No. 2007-249151). The powder supplying device includes an air pump that discharges air toward the powder accommodating portion, and a suction pump that sucks toner accommodated in the powder accommodating portion toward the toner hopper.

### SUMMARY

According to a first aspect of the present disclosure, an image forming apparatus includes a first cartridge configured to accommodate first toner, a second cartridge configured to accommodate second toner, and an apparatus body to which the first cartridge and the second cartridge are detachably attached. The apparatus body includes a pump portion configured to discharge air, a first developer container including a first toner accommodating portion configured to accommodate the first toner, a second developer container including a second toner accommodating portion configured to accommodate the second toner, a first tube including a first end communicated with an interior of the first cartridge, and a second end communicated with an interior of the first toner accommodating portion, the first tube being configured to extend from the first end to the second end and to have the first toner pass therethrough, and a second tube including a third end communicated with an interior of the second cartridge and a fourth end communicated with the interior of the second toner accommodating portion, the second tube being configured to extend from the third end to the fourth end and to have the second toner pass therethrough. The first cartridge includes a first toner chamber configured to accommodate the first toner, a first filter configured to block passage of the first toner while allowing passage of air, a first air chamber arranged adjacent to the first toner chamber via the first filter, the first air chamber being provided with a first intake port that takes in air discharged from the pump portion, a first discharge port configured to discharge the first toner accommodated in the first toner chamber to an exterior of the first cartridge, the first discharge port being connected to the first end of the first tube, and a first pipe configured to communicate with the first discharge port and through which the first toner discharged from the first discharge port passes, the first toner within the first toner chamber being discharged from the first discharge port and conveyed through the first tube to the first toner accommodating portion by air taken in from the first intake port of the first cartridge. The second cartridge includes a second toner chamber configured to accommodate the second toner, a second filter configured to block passage of the second toner while allowing passage of air, a second air chamber arranged adjacent to the second toner chamber via the second filter, the second air chamber being provided with a second intake port that takes in air discharged from the pump portion, a second discharge port configured to discharge the second toner accommodated in the second toner chamber to an exterior of the second cartridge, the second discharge port being connected to the third end of the second tube, and a second pipe configured to communicate with the second discharge port and through which the second toner discharged from the second discharge port passes, the second toner within the second toner chamber being discharged from the second discharge port and conveyed through the second tube to the second toner accommodating portion by air taken in from the second intake port of the second cartridge. A portion, of the first tube, which is longer than half a length from the first end to the second end is configured to extend, in a direction in which the first toner is conveyed, in a horizontal direction, a downwardly inclined direction, or an upwardly inclined direction at an angle of 45 degrees or less with respect to the horizontal direction. A portion, of the second tube, which is longer than half a length from the third end to the fourth end is configured to extend, in a direction in which the second toner is conveyed, in the horizontal direction, a downwardly inclined direction, or an upwardly inclined direction at an angle of 45 degrees or less with respect to the horizontal direction. The length from the first end to the second end of the first tube is longer than the length from the third end to the fourth end of the second tube. A cross-sectional area of an interior space of the first tube is larger than a cross-sectional area of an interior space of the second tube.

According to a second aspect of the present disclosure, an image forming apparatus includes a first cartridge configured to accommodate first toner, a second cartridge configured to accommodate second toner, and an apparatus body to which the first cartridge and the second cartridge are detachably attached. The apparatus body includes a pump portion configured to discharge air, a first developer container including a first toner accommodating portion configured to accommodate the first toner, a second developer container including a second toner accommodating portion configured to accommodate the second toner, a first tube including a first end communicated with an interior of the first cartridge, and a second end communicated with an interior of the first toner accommodating portion, the first tube being configured to extend from the first end to the second end and to have the first toner pass therethrough, and a second tube including a third end communicated with an interior of the second cartridge and a fourth end communicated with the interior of the second toner accommodating portion, the second tube being configured to extend from the third end to the fourth end and to have the second toner pass therethrough. The first cartridge includes a first toner chamber configured to accommodate the first toner, a first filter configured to block passage of the first toner while allowing passage of air, a first air chamber arranged adjacent to the first toner chamber via the first filter, the first air chamber being provided with a first intake port that takes in air discharged from the pump portion, a first discharge port configured to discharge the first toner accommodated in the first toner chamber to an exterior of the first cartridge, the first discharge port being connected to the first end of the first tube, and a first pipe configured to communicate with the first discharge port and through which the first toner discharged from the first discharge port passes, the first toner within the first toner chamber being discharged from the first discharge port and conveyed through the first tube to the first toner accommodating portion by air taken in from the first intake port of the first cartridge. The second cartridge includes a second toner chamber configured to accommodate the second toner, a second filter configured to block passage of the second toner while allowing passage of air, a second air chamber arranged adjacent to the second toner chamber via the second filter, the second air chamber being provided with a second intake port that takes in air discharged from the pump portion, a second discharge port configured to discharge the second toner accommodated in the second toner chamber to an exterior of the second cartridge, the second discharge port being connected to the third end of the second tube, and a second pipe configured to communicate with the second discharge port and through which the second toner discharged from the second discharge port passes, the second toner within the second toner chamber being discharged from the second discharge port and conveyed through the second tube to the second toner accommodating portion by air taken in from the second intake port of the second cartridge. A portion, of the first tube, which is longer than half a length from the first end to the second end is configured to extend, in a direction in which the first toner is conveyed, in an upper direction opposite to a gravity direction, an upwardly inclined direction, or a downwardly inclined direction at an angle of 45 degrees or less with respect to a horizontal direction. A portion, of the second tube, which is longer than half a length from the third end to the fourth end is configured to extend, in a direction in which the second toner is conveyed, in the upper direction, an upwardly inclined direction, or a downwardly inclined direction at an angle of 45 degrees or less with respect to the horizontal direction. The length from the first end to the second end of the first tube is longer than the length from the third end to the fourth end of the second tube. A cross-sectional area of an interior space of the first tube is smaller than a cross-sectional area of an interior space of the second tube.

According to a third aspect of the present disclosure, an image forming apparatus includes a first cartridge configured to accommodate first toner, a second cartridge configured to accommodate second toner, and an apparatus body to which the first cartridge and the second cartridge are detachably attached. The apparatus body includes a pump portion configured to discharge air, a first developer container including a first toner accommodating portion configured to accommodate the first toner, a second developer container including a second toner accommodating portion configured to accommodate the second toner, a first tube including a first end communicated with an interior of the first cartridge, and a second end communicated with an interior of the first toner accommodating portion, the first tube being configured to extend from the first end to the second end and to have the first toner pass therethrough, and a second tube including a third end communicated with an interior of the second cartridge and a fourth end communicated with the interior of the second toner accommodating portion, the second tube being configured to extend from the third end to the fourth end and to have the second toner pass therethrough. The first cartridge includes a first toner chamber configured to accommodate the first toner, a first filter configured to block passage of the first toner while allowing passage of air, a first air chamber arranged adjacent to the first toner chamber via the first filter, the first air chamber being provided with a first intake port that takes in air discharged from the pump portion, a first discharge port configured to discharge the first toner accommodated in the first toner chamber to an exterior of the first cartridge, the first discharge port being connected to the first end of the first tube, and a first pipe configured to communicate with the first discharge port and through which the first toner discharged from the first discharge port passes, the first toner within the first toner chamber being discharged from the first discharge port and conveyed through the first tube to the first toner accommodating portion by air taken in from the first intake port of the first cartridge. The second cartridge includes a second toner chamber configured to accommodate the second toner, a second filter configured to block passage of the second toner while allowing passage of air, a second air chamber arranged adjacent to the second toner chamber via the second filter, the second air chamber being provided with a second intake port that takes in air discharged from the pump portion, a second discharge port configured to discharge the second toner accommodated in the second toner chamber to an exterior of the second cartridge, the second discharge port being connected to the third end of the second tube, and a second pipe configured to communicate with the second discharge port and through which the second toner discharged from the second discharge port passes, the second toner within the second toner chamber being discharged from the second discharge port and conveyed through the second tube to the second toner accommodating portion by air taken in from the second intake port of the second cartridge. An entire length of the first tube is equal to an entire length of the second tube.

According to a fourth aspect of the present disclosure, an image forming apparatus includes a cartridge configured to accommodate toner, and an apparatus body to which the cartridge is detachably attached. The apparatus body includes a pump portion configured to discharge air, a developer container including a toner accommodating portion configured to accommodate the toner, the developer container being arranged above the cartridge, and a tube including a first end communicated with an interior of the cartridge, and a second end communicated with an interior of the toner accommodating portion, the tube being configured to extend from the first end to the second end and to have the toner pass therethrough. The cartridge includes a toner chamber configured to accommodate the toner, a filter configured to block passage of the toner while allowing passage of air, an air chamber arranged adjacent to the toner chamber via the filter, the air chamber being provided with an intake port that takes in air discharged from the pump portion, a discharge port configured to discharge the toner accommodated in the toner chamber to an exterior of the cartridge, the discharge port being connected to the first end of the tube, and a pipe configured to communicate with the discharge port and through which the toner discharged from the discharge port passes, the toner within the toner chamber being discharged from the discharge port and conveyed through the tube to the toner accommodating portion by air taken in from the intake port of the cartridge. The tube includes a first portion and a second portion that extend, in a direction in which the toner is conveyed, in a vertical direction or a direction at an inclination angle greater than 60 degrees with respect to a horizontal direction between the first end and the second end, and a third portion that extends in the horizontal direction, a downwardly inclined direction, or an upwardly inclined direction at an angle of 15 degrees or less with respect to the horizontal direction between the first portion and the second portion.

Features of the present disclosure will become apparent from the following description of embodiments with reference to the attached drawings. The following description of embodiments is described by way of example.

### BRIEF DESCRIPTION OF THE DRAWINGS

FIG. 1 is an entire schematic diagram of an image forming apparatus according to a first embodiment.

FIG. 2 is a cross-sectional view of a process cartridge.

FIGS. 3A and 3B are each a cross-sectional view of a toner cartridge, wherein FIG. 3A illustrates a state in which a lid member is opened, and FIG. 3B illustrates a state in which the lid member is closed.

FIG. 4 is a perspective view of the toner cartridge cut at an XY plane.

FIG. 5 is an exploded perspective view of the toner cartridge cut at the XY plane.

FIG. 6 is a perspective view of a filter.

FIG. 7 is an enlarged view of a joint portion of a first frame body and a second frame body.

FIG. 8 is a bottom view illustrating the first frame body.

FIG. 9 is a cross-sectional view illustrating a state in which the toner cartridge is connected via a passage to a developer container.

FIG. 10A is a cross-sectional view illustrating a state in which discharge of toner is not started.

FIG. 10B is a cross-sectional view illustrating a state in which discharge of toner has been started by air taken in through an intake port.

FIG. 10C is a cross-sectional view illustrating a state in which toner is discharged further from the state illustrated in FIG. 10B.

FIG. 10D is a cross-sectional view illustrating a state in which a portion of an inclined portion of the filter is exposed.

FIG. 11 is a block diagram of a portion of a control system of the image forming apparatus.

FIG. 12 is a plan view of a toner conveyance path according to the first embodiment.

FIGS. 13A and 13B are each a front view of the toner conveyance path, wherein FIG. 13A illustrates a path through which black toner passes, and FIG. 13B illustrates a path through which yellow toner passes.

FIG. 14 is a front view of a toner conveyance path according to a second embodiment.

FIGS. 15A and 15B are each a cross-sectional view of a toner conveyance path according to a third embodiment, wherein FIG. 15A illustrates a toner conveyance path having a true circular cross-sectional shape, and FIG. 15B illustrates a toner conveyance path having an elliptical cross-sectional shape.

FIG. 16 is a plan view of a toner conveyance path according to a fourth embodiment.

FIG. 17 is a plan view of a toner conveyance path according to a fifth embodiment.

FIGS. 18A and 18B are each a schematic view of a toner conveyance path, wherein FIG. 18A illustrates a toner conveyance path according to a comparative example, and FIG. 18B illustrates a toner conveyance path according to a sixth embodiment.

### DESCRIPTION OF THE EMBODIMENTS

Dimensions, materials, shapes, and relative arrangements of components described in the following description of embodiments may be modified arbitrarily according to the configuration of apparatuses and various conditions.

Examples of image forming apparatuses according to the following description include a copying machine, a printer, a multifunction machine, and a commercial printing apparatus. In such image forming apparatuses, images are formed on recording materials based on image information entered from an external apparatus or image information read from a document. The image forming apparatus may include, in addition to a main body having an image forming function, auxiliary devices such as an option feeder, an image reading apparatus, and a sheet processing apparatus connected thereto, and in that case, the entire system including the connected auxiliary device is also referred to as one type of the image forming apparatus. The recording material may include sheets of various materials and shapes, such as paper including normal paper and thick paper, plastic films, coated paper, sheets having special shapes such as envelopes and index paper, and cloths.

### First Embodiment

### Entire Configuration

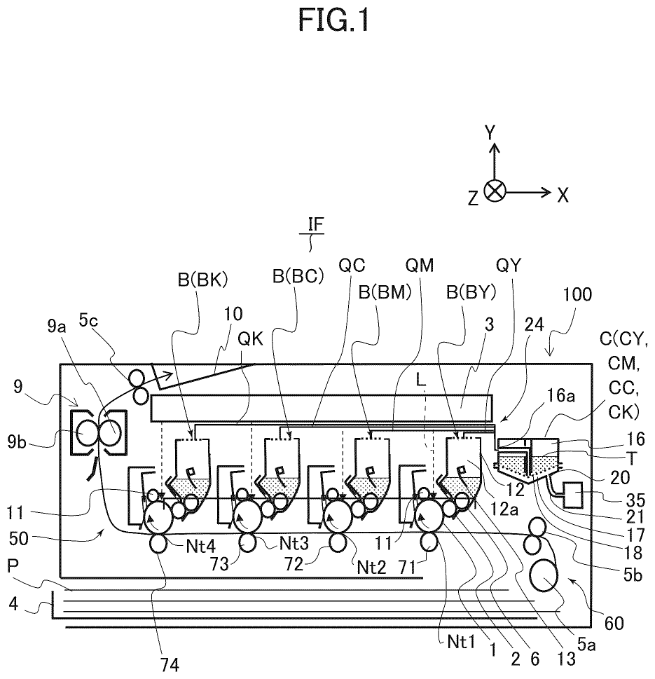

At first, a first embodiment of the present disclosure will be described. An image forming apparatus IF according to a first embodiment is a laser beam printer adopting an electrophotographic system. The image forming apparatus IF includes, as illustrated in FIG. 1, an image forming unit 50 for forming an image on a sheet P, a sheet feed unit 60, a fixing unit 9, and a sheet discharge roller pair 5c. The image forming unit 50 includes four process cartridges BY, BM, BC, and BK for respectively forming toner images of four colors, which are yellow (Y), magenta (M), cyan (C), and black (K), and a scanner unit 3. The scanner unit 3 is arranged above the process cartridges BY, BM, BC, and BK. Alternatively, instead of the scanner unit 3, an LED exposing unit including an LED array in which a plurality of LEDs are aligned along a longitudinal direction of the photosensitive drum may be adopted.

The portion having excluded the respective process cartridges BY, BM, BC, and BK and toner cartridges CY, CM, CC, and CK which will be described later from the image forming apparatus IF may sometimes be referred to as a main body of the image forming apparatus IF, or an apparatus body 100. In the following description, the toner cartridges CY, CM, CC, and CK may be referred to simply as cartridges CY, CM, CC, and CK. The process cartridges BY, BM, BC, and BK may be supported attachably and detachably with respect to the apparatus body 100 or may be fixed in a non-detachable manner with respect to the apparatus body 100.

In the present embodiment, Y, M, C, and K are attached as suffix to reference numbers of components corresponding to respective color toners of yellow, magenta, cyan, and black. The configurations and operations of components to which these suffixes are attached are approximately the same, except for the different toner colors. Therefore, in the following description, unless distinction is necessary, the suffixes Y to K may be omitted to provide a general description. That is, the process cartridges BY, BM, BC, and BK may be described inclusively as process cartridge B, and the toner cartridges CY, CM, CC, and CK may be described inclusively as toner cartridge C.

Further, in the following description, unless denoted otherwise, directions (X, Y, Z) are defined as follows, assuming that the process cartridges BY, BM, BC, and BK and the toner cartridges CY, CM, CC, and CK take a normal position, that is, a position at which the cartridges are attached to the apparatus body 100.

As illustrated in FIG. 1, a front-rear direction is denoted by an X axis, and a direction from a rear side toward a front side of the image forming apparatus IF is referred to as an X direction. The X direction may be referred to as a front direction. Further, a downstream side in the X direction of the image forming apparatus IF may be referred to as a front side, and an upstream side may be referred to as a rear side.

A right-left direction is denoted by a Z axis, and a direction from left to right of the image forming apparatus IF is referred to as a Z direction. The Z direction may also be referred to as a right direction. Further, a downstream side in the Z direction of the image forming apparatus IF may be referred to as a right side, and an upstream side thereof may be referred to as a left side.

An up-down direction is denoted by a Y axis, and a direction from down to up of the image forming apparatus IF is referred to as a Y direction. The Y direction may also be referred to as an upper direction, a height direction, or a vertical direction. Further, the downstream side in the Y direction of the image forming apparatus IF may be referred to as an upper side, an upper surface side, or a top surface side, and the upstream side may be referred to as a lower side, a lower surface side, or a bottom surface side.

The X axis, the Y axis, and the Z axis are in a mutually perpendicular relationship. For example, the X axis is perpendicular to the Y axis, and is also perpendicular to the Z axis. Further, the plane perpendicular to the X axis may be referred to as a YZ plane, a plane perpendicular to the Y axis may be referred to as a ZX plane, and a plane perpendicular to the Z axis may be referred to as an XY plane. For example, an XZ plane is a horizontal plane. The X direction and the Z direction are directions along the XZ plane which is the horizontal plane, or in other words, are a horizontal direction.

The process cartridge BY includes the photosensitive drum 1, a developing roller 2, a charging roller 11, and a developer container 12 including a toner accommodating portion 12a that accommodates toner to be supplied to the developing roller 2. Similarly, the process cartridges BM, BC, and BK each include the photosensitive drum, the developing roller, the charging roller, and the developer container including the toner accommodating portion that accommodates toner to be supplied to the developing roller. The photosensitive drum 1 is composed by coating an organic photoconductive layer on an outer circumference of an aluminum cylinder, and it is rotated by a drive motor not shown. Alternatively, a photosensitive belt may be used instead of the photosensitive drum 1.

The four process cartridges BY, BM, BC, and BK are aligned along the X direction. Further, the image forming unit 50 includes transfer rollers 71, 72, 73, and 74 that come into contact with each developing roller 2 of the process cartridges BY, BM, BC, and BK, and that form transfer portions Nt1, Nt2, Nt3, and Nt4. For example, the transfer roller 71 comes into contact with the photosensitive drum 1 of the process cartridge BY, and forms the transfer portion Nt1.

The fixing unit 9 includes a heating roller 9a heated by a heater, and a pressing roller 9b that comes into pressure contact with the heating roller 9a. Alternatively, a fixing film that slides against a heater and rotates or a fixing belt having a conductive layer that is heated by electromagnetic induction heating may be applied instead of the heating roller 9a.

The sheet feed unit 60 is disposed at a lower portion of the image forming apparatus IF. The sheet feed unit 60 includes a tray 4 that may be drawn out from or attached to the apparatus body 100, and a feed roller 5a for feeding the sheets P accommodated in the tray 4.

The toner cartridges CC, CY, CM, and CK are supported attachably and detachably to and from the apparatus body 100. The toner cartridges CC, CY, CM, and CK each accommodate toner T that may be supplied to the toner accommodating portion 12a of the developer container 12 in each of the process cartridges BY, BM, BC, and BK.

### Image Forming Operation

Next, an image forming operation of the image forming apparatus IF configured as above will be described. When an image signal is entered to the scanner unit 3 from a personal computer not shown, a laser light L corresponding to the image signal is irradiated from the scanner unit 3 on the photosensitive drums 1 of the respective process cartridges BY, BM, BC, and BK.

In this state, a surface of the photosensitive drum 1 has been charged uniformly in advance to a predetermined polarity and potential by the charging roller 11, and by irradiating the laser light L thereon from the scanner unit 3, an electrostatic latent image is formed on a surface thereof. The electrostatic latent image formed on the photosensitive drum 1 is developed by the developing roller 2, and a toner image is formed on the photosensitive drum 1. That is, toner images of yellow (Y), magenta (M), cyan (C), and black (K) are formed on the respective photosensitive drums 1 of the process cartridges BY, BM, BC, and BK.

In parallel with the image forming process, the sheet P being accommodated in the tray 4 of the sheet feed unit 60 is conveyed toward the transfer portion Nt1. In the transfer portion Nt1, a yellow (Y) toner image on the photosensitive drum 1 is transferred onto the sheet P by a secondary transfer bias applied to the transfer roller 71. Similarly, magenta (M), cyan (C), and black (K) toner images are transferred onto the sheet P at transfer portions Nt2, Nt3, and Nt4. After having the toner images of respective colors transferred onto the sheet P, toner remaining on the surface of each photosensitive drum is removed by a cleaning device not shown.

Predetermined heat and pressure are applied by the heating roller 9a and the pressing roller 9b of the fixing unit 9 to the sheet P having the toner images of respective colors transferred thereto, by which toner is melted and solidified, i.e., fixed. The sheet P having passed through the fixing unit 9 is discharged toward a direction along the X direction by the sheet discharge roller pair 5c, and supported on a sheet discharge tray 10 disposed on an upper portion of the apparatus body 100.

### Process Cartridge

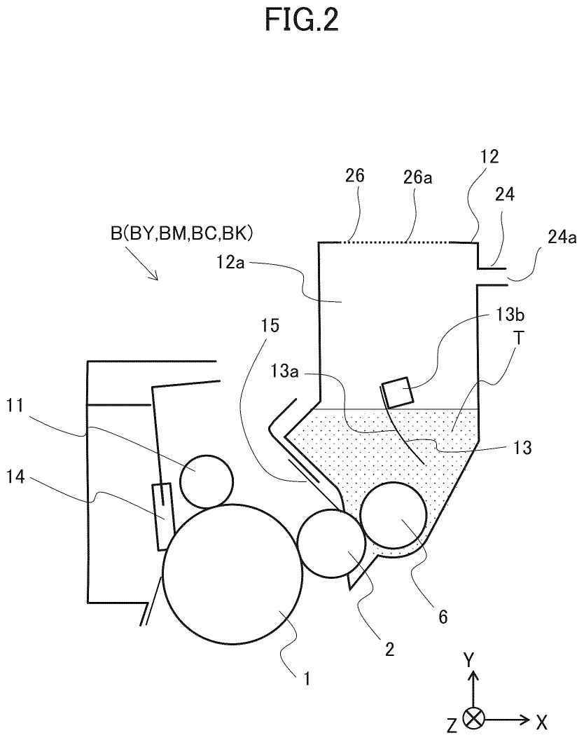

Next, the process cartridge B will be described in further detail with reference to FIG. 2. FIG. 2 is a cross-sectional view illustrating the process cartridge B. The process cartridge B includes the photosensitive drum 1 and a processing unit that acts on the photosensitive drum 1. In the present embodiment, the processing unit includes the charging roller 11, the developing roller 2, a developing blade 15, and a cleaning blade 14.

Further, the process cartridge B is composed of a drum unit serving as an image bearing member unit, and a developing unit serving as an image developing unit. The drum unit includes the charging roller 11 positioned in the circumference of the photosensitive drum 1 and the cleaning blade 14 having elasticity. The developing unit includes the developing roller 2, the developing blade 15, a supply roller 6, the developer container 12 including the toner accommodating portion 12a that accommodates toner T, and an agitating member 13.

The agitating member 13 includes a rotation shaft 13a, and an agitating sheet 13b fixed to the rotation shaft 13a and having flexibility, the agitating member 13 agitating the toner T accommodated in the toner accommodating portion 12a by rotating. Further, the developer container 12 includes a passage 24 through which toner supplied from the toner cartridge C passes, an intake port 24a through which supplied toner is taken in, and an opening 26 through which air within the toner accommodating portion 12a is passed through to an exterior of the developer container 12. In the position during use of the image forming apparatus IF, the intake port 24a and the opening 26 are disposed on an upper portion of the developer container 12, and the opening 26 is covered by a filter 26a. According to the present embodiment, the opening 26 is formed of a through hole through which an interior of the toner accommodating portion 12a and the exterior of the developer container 12 are communicated. The filter 26a is composed of a porous member formed of resin fiber, for example. The pores of the filter 26a are designed to have a size and density that allows air to pass through and that regulates the passing of toner T. In other words, the filter 26a is configured to allow passage of air and to block passage of toner T.

### General Configuration of Toner Cartridge

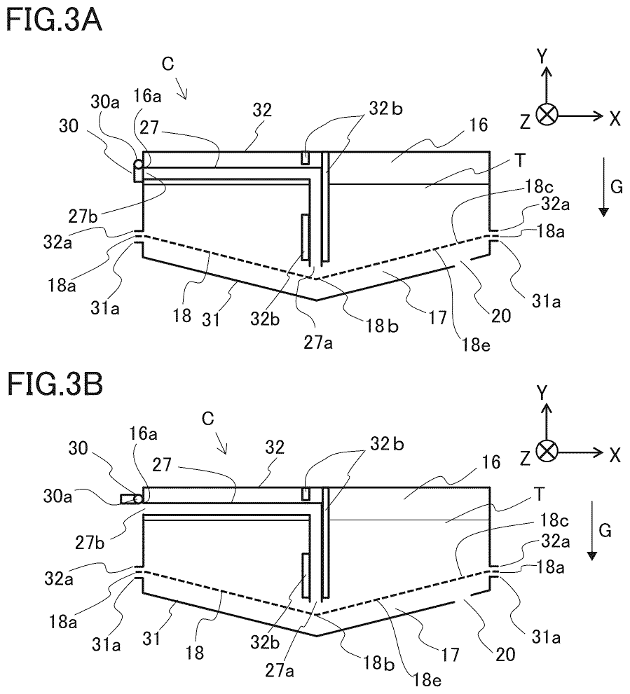

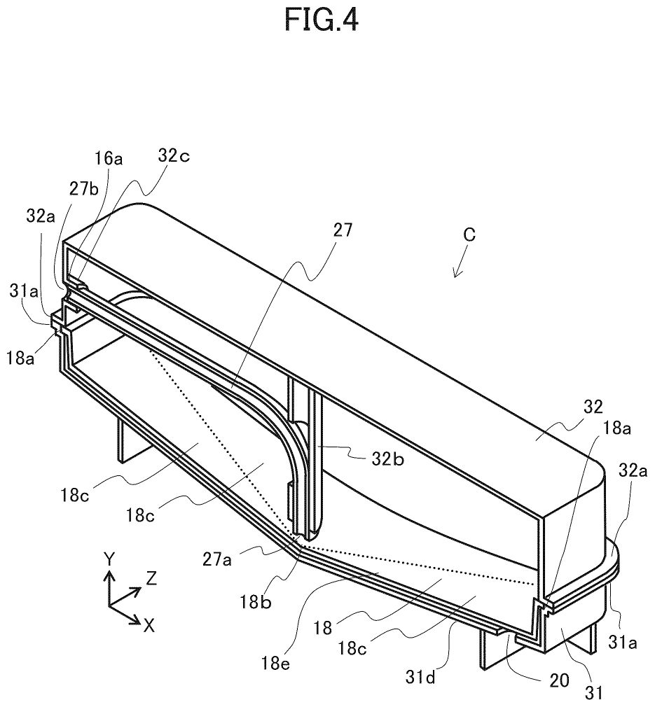

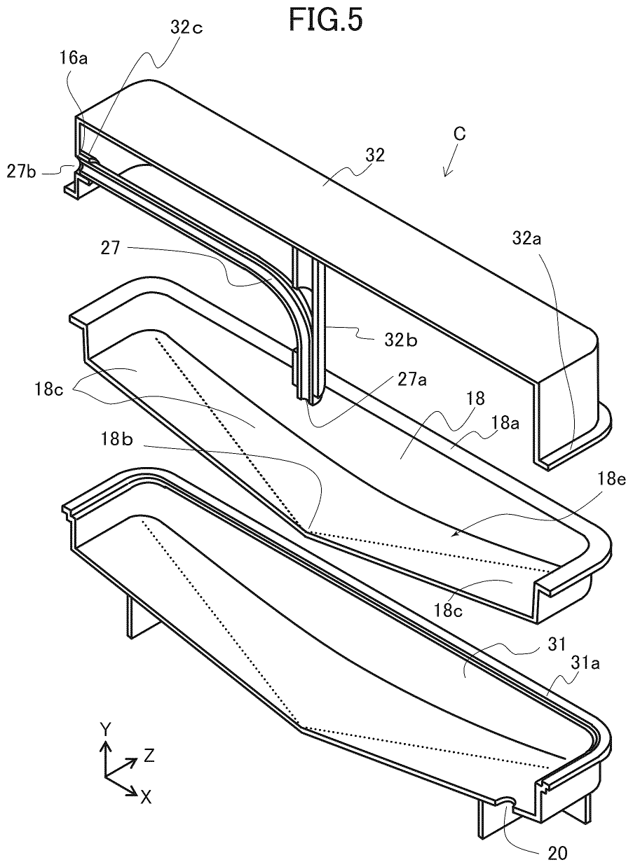

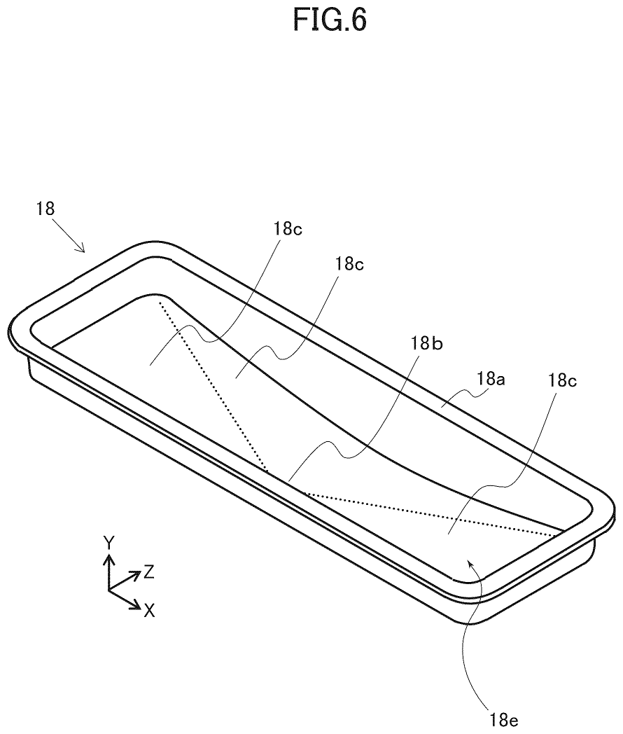

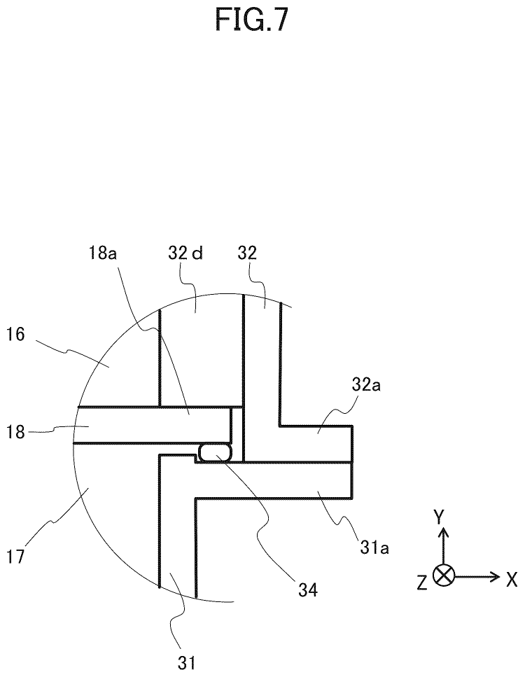

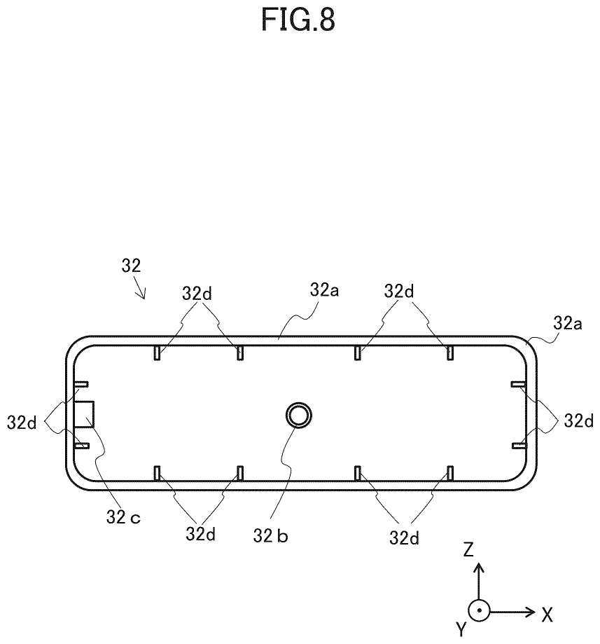

Next, with reference to FIGS. 3A to 8, the general configuration of the toner cartridges CY, CM, CC, and CK will be described. FIG. 3A is a cross-sectional view of the toner cartridge C with a lid member 30 opened, and FIG. 3B is a cross-sectional view of the toner cartridge C with the lid member 30 closed. FIG. 4 is a perspective view of the toner cartridge C cut at an XY plane. FIG. 5 is an exploded perspective view of the toner cartridge C cut at the XY plane. FIG. 6 is a perspective view illustrating a filter 18. FIG. 7 is an enlarged view illustrating a joint portion of a first frame body 32 and a second frame body 31. FIG. 8 is a bottom view illustrating the first frame body 32.

The image forming apparatus IF includes a front door not shown that is supported in an openable and closable manner with respect to the casing of the apparatus body 100. The front door covers an opening formed on a front portion of the apparatus body 100, that is, disposed at a downstream end portion in the X direction, by being positioned at a closed position. The front door opens the opening of the apparatus body 100 by being positioned at an opened position. The front door may maintain its position at the opened position. When the front door is opened from the closed position to the opened position, the toner cartridges CY, CM, CC, and CK are exposed to the exterior of the image forming apparatus IF through the opening. Thereby, the user may be able to access the toner cartridges CY, CM, CC, and CK.

The toner cartridges CY, CM, CC, and CK are arranged on a downstream side in the X direction of the apparatus body 100, that is, on the front side of the apparatus body 100. In other words, the toner cartridges CY, CM, CC, and CK are arranged on the downstream side of the apparatus body 100 in a sheet discharging direction of the sheet discharge roller pair 5c. Further, the toner cartridges CY, CM, CC, and CK are arranged along the Z direction. That is, the X direction which is the direction along which the process cartridges BY, BM, BC, and BK are aligned and the Z direction which is the direction along which the toner cartridges CY, CM, CC, and CK are aligned intersect each other.

The toner cartridges CY, CM, CC, and CK are supported attachably and detachably in the X direction with respect to the apparatus body 100. Therefore, the toner cartridges CY, CM, CC, and CK may be replaced without removing the process cartridges BY, BM, BC, and BK from the apparatus body 100. The toner cartridges CY, CM, CC, and CK are arranged on the front side of the apparatus body 100 and exposed by opening the front door, such that they may be replaced easily.

The toner cartridges CY, CM, CC, and CK each have a similar configuration, and in the following description, the toner cartridges CY, CM, CC, and CK are generally collectively described mainly as the toner cartridge C. In the following description, unless denoted otherwise, directions (X, Y, Z) are defined as illustrated in FIGS. 3A to 16 assuming that the toner cartridge C takes the position described below. That is, the following description assumes that the toner cartridge C takes a position in which a toner chamber 16, the filter 18, and an air chamber 17 are aligned in this order from the upper direction with respect to a gravity direction G, which is a direction opposite to the Y direction (refer to FIG. 3A), and in which a short direction, i.e., Z direction, and a longitudinal direction, i.e., X direction, of the toner cartridge C are parallel to a horizontal direction perpendicular to the gravity direction G.

In this position, the toner cartridge C is oriented in a predetermined orientation such that the gravity direction is the direction opposite to the Y direction and that at least a portion of the toner chamber 16 is positioned above the air chamber 17. The short direction of the toner cartridge C in this state is referred to as the Z direction, the longitudinal direction is referred to as the X direction, and the opposite direction to the gravity direction is referred to as the Y direction. That is, the gravity direction G is the direction along which the second frame body 31 and the first frame body 32 described later are aligned. In other words, the gravity direction G is the direction along which the toner chamber 16 and the air chamber 17 are aligned. The X direction is the longitudinal direction of the toner cartridge C when viewed in the gravity direction G. The Z direction is a short direction of the first frame body 32 intersecting both the X direction and the Y direction, and it is also a longitudinal direction of the developer container 12.

A front-rear direction of the toner cartridge C is denoted by the X axis, and the direction from the rear side toward the front side is referred to as the X direction. The X direction may also be referred to as the front direction. A downstream side in the X direction of the toner cartridge C may be referred to as the front side, and an upstream side thereof may be referred to as the rear side.

The right-left direction of the toner cartridge C is denoted by the Z axis, and the direction from left to right of the toner cartridge C is referred to as the X direction. The Z direction may also be referred to as the right direction. Further, the downstream side in the Z direction of the toner cartridge C may be referred to as the right side, and the upstream side thereof may be referred to as the left side.

The up-down direction of the toner cartridge C is denoted by the Y axis, and the direction from down to up of the toner cartridge C is referred to as the Y direction. The Y direction may also be referred to as the upper direction, the height direction, or the vertical direction. Further, the downstream side in the Y direction of the toner cartridge C may be referred to as the upper side, the upper surface side, or the top surface side, and the upstream side may be referred to as the lower side, the lower surface side, or the bottom surface side.

The toner cartridge C includes, as illustrated in FIGS. 3A to 5, the first frame body 32 serving as a first container, the second frame body 31 serving as a second container, the filter 18, and a discharge pipe 27 serving as a pipe. In the present embodiment, the first frame body 32 and the second frame body 31 are formed of a resin material, but they may also be formed of paper. The filter 18 is retained in a state sandwiched between the first frame body 32 and the second frame body 31, as will be described in detail later.

An interior space of the toner cartridge C is partitioned by the filter 18 into the toner chamber 16 and the air chamber 17. That is, the toner chamber 16 is composed of the first frame body 32 and the filter 18, and the air chamber 17 is composed of the second frame body 31 and the filter 18. The air chamber 17 is arranged below the filter 18, and the toner chamber 16 is arranged above the filter 18. That is, the air chamber 17 is adjacent to the toner chamber 16 via the filter 18. No partition is provided in the air chamber 17, and the air chamber 17 is the only chamber, i.e., room or space, that is adjacent to the toner chamber 16 via the filter 18.

The toner chamber 16 is configured to accommodate toner T, and toner T is supported by the filter 18 in the gravity direction within the toner chamber 16. Toner T is not accommodated within the air chamber 17. The filter 18 is composed of a porous member formed of resin fiber, for example. The pores of the filter 18 are designed to have a size and density that allows air to pass through and regulates the passing of toner T. In other words, the filter 18 is configured to allow passage of air and to block passage of toner T.

A discharge port 16a through which toner within the toner chamber 16 is discharged to the exterior of the toner cartridge C is disposed on the rear side of the first frame body 32. In other words, the discharge port 16a is disposed on the toner chamber 16. The discharge port 16a is composed of a through hole that passes through the first frame body 32 in the X direction. An intake port 20 composed of a port that passes through the second frame body 31 in the Y direction is disposed on a lower surface 31d of the second frame body 31. In other words, the intake port 20 is disposed on the air chamber 17. The discharge port 16a and the intake port 20 are communicated with the exterior of the toner cartridge C.

The apparatus body 100 of the image forming apparatus IF includes, as illustrated in FIG. 1, a pump 35 and an air supply pipe 21. The air supply pipe 21 connects the pump 35 and the intake port 20 of the toner cartridge C, and the pump 35 is configured to supply air to the air chamber 17 of the toner cartridge C via the air supply pipe 21. The pump 35 is arranged below the toner cartridge C. The pump 35 is composed of a positive displacement pump, such as a reciprocating pump or a rotary pump, but is not limited thereto. For example, the pump 35 may be composed of a non-positive displacement pump, such as a centrifugal pump, a propeller pump, or a viscosity pump.

The reciprocating pump is a pump that performs suction and discharge through reciprocation of a piston or a plunger, and examples of the reciprocating pump include a piston pump, a plunger pump, and a diaphragm pump. The rotary pump is a pump that performs suction and discharge by rotation of a gear or a rotor, and examples of the rotary pump include a gear pump, a screw pump, and a vane pump.

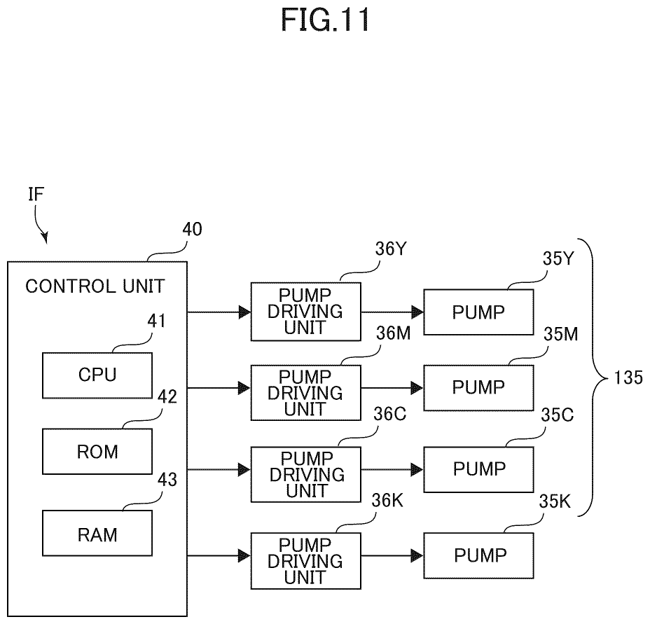

In the present embodiment, the number of the pump 35 being disposed on the apparatus body 100 is the same number as the toner cartridge C. That is, there are four pumps 35 disposed to correspond to the four toner cartridges CY, CM, CC, and CK, and if the pumps are to be distinguished, the pumps discharging air to each of the toner cartridges CY, CM, CC, and CK are respectively referred to as the pump 35Y, 35M, 35C, and 35K, as illustrated in FIG. 11. The four pumps 35Y, 35M, 35C, and 35K are each connected to the toner cartridges CY, CM, CC, and CK via the air supply pipe 21. The configurations of the pumps 35Y, 35M, 35C, and 35K are approximately the same.

In the present embodiment, the pump 35 is connected to the intake port 20 via the air supply pipe 21, but the present technique is not limited thereto. For example, the pump 35 may be directly connected to the intake port 20 of the toner cartridge C, but the pump may also be connected to the intake port 20 via the passage composed of the frame body of the apparatus body 100.

Further, the four pumps 35Y, 35M, 35C, and 35K may be composed as a single pump unit, or as two or three pump units. According to the present embodiment, the pumps 35Y, 35M, 35C, and 35K are disposed on the apparatus body 100, but alternatively, the pumps may be disposed on each of the toner cartridges CY, CM, CC, and CK and the process cartridges BY, BM, BC, and BK.

The discharge port 16a disposed on the first frame body 32 of the toner cartridge C is opened toward the upstream side in the X direction. Therefore, when attaching the toner cartridge C toward the upstream side in the X direction with respect to the apparatus body 100, the discharge port 16a may be easily engaged to be communicated with toner conveyance paths T1 to T4 described later disposed in the apparatus body 100.

The arrangement is not limited to that described above, and the discharge port 16a may be disposed on the lower surface 31d or the upper surface of the toner cartridge C, and the intake port 20 may be disposed on the rear side or the upper surface of the toner cartridge C. Further, if there is enough space in the apparatus body 100, the discharge port 16a and the intake port 20 may be disposed on both right and left side surfaces among the respective side surfaces of the toner cartridge C.

Further, the first frame body 32 of the toner cartridge C supports the lid member 30 that seals the discharge port 16a rotatably about a pivot shaft 30a. In a state where the toner cartridge C is not attached to the apparatus body 100 and the discharge port 16a of the toner cartridge C is not connected to the passage 24, the lid member 30 is positioned at the closed position illustrated in FIG. 3A. In the closed position, the lid member 30 seals the discharge port 16a and suppresses toner within the toner chamber 16 from leaking to the exterior of the toner cartridge C.

Meanwhile, in a state where the toner cartridge C is attached to the apparatus body 100 and the discharge port 16a of the toner cartridge C is connected to the passage 24, the lid member 30 is positioned at the opened position illustrated in FIG. 3B. The lid member 30 opens the discharge port 16a in the opened position, and allows toner T to be supplied from the toner cartridge C via the passage 24 to the process cartridge B. The lid member 30 is not limited to an open/close member as according to the present embodiment, and for example, it may be composed of a sealing member that may be detachably attached to the toner cartridge C or a sliding member that may be slid with respect to the toner cartridge C.

As illustrated in FIGS. 3A to 5, the first frame body 32 includes a first box portion that forms the toner chamber 16, and a first flange portion 32a that extends in the approximately horizontal direction from the lower end portion of the first box portion toward the outer side of the toner chamber 16. The first box portion is formed in an approximately rectangular parallelepiped shape. The first flange portion 32a is formed across an entire circumference of a lower end portion of the first box portion.

Further, as illustrated in FIG. 8, a plurality of ribs 32d are disposed on an inner wall of the first box portion of the first frame body 32. The plurality of ribs 32d extend toward the inner side of the toner chamber 16 in correspondence with a region in which a second flange portion 31a of the second frame body 31 is formed. The plurality of ribs 32d face the second flange portion 31a of the second frame body 31 in the Y direction.

The second frame body 31 is formed as a separate member as the first frame body 32, and includes a second box portion that forms the air chamber 17 and the second flange portion 31a that extends in an approximately horizontal direction from an upper end portion of the second box portion toward the outer side of the air chamber 17. The second flange portion 31a is formed across an entire circumference of the upper end portion of the second box portion.

The filter 18 includes, as illustrated in FIGS. 3A to 6, a bottom surface portion 18e that serves as a partition portion partitioning the air chamber 17 and the toner chamber 16, and an outer edge portion 18a that is sandwiched between and held by the first flange portion 32a and the second flange portion 31a. The bottom surface portion 18e is composed of a plurality of inclined portions 18c that are formed to extend downward in the gravity direction G as it approaches a lowest portion 18b of the filter 18, and constitutes a bottom surface of the toner chamber 16. The lowest portion 18b is disposed at a center portion of the filter 18 in the X direction and the Z direction.

The filter 18 is composed of a filter material formed by hot pressing or of a fibrous sheet material. Furter, the filter 18 is formed of a single continuous member, and the bottom surface portion 18e of the filter 18 is configured to be parallel with the bottom surface shape of the second frame body 31.

The frame body of the toner cartridge C is formed by mutually joining the first flange portion 32a and the second flange portion 31a by ultrasonic welding, such that no air leaks between the first flange portion 32a and the second flange portion 31a. The joining of the first flange portion 32a and the second flange portion 31a is not limited to ultrasonic welding, and the portions may be fixed by thermal welding, by an adhesive such as double-sided tape or hot melting, or through use of a screw.

By joining the first flange portion 32a and the second flange portion 31a, the outer edge portion 18a of the filter 18 and a sealing member 34 are sandwiched between the plurality of ribs 32d of the first frame body 32 and the second flange portion 31a. The sealing member 34 is composed of a member having flexibility, such as rubber or silicon. As described, the filter 18 is held by being sandwiched together with the sealing member 34 between the first frame body 32 and the second frame body 31. If the holding force of the filter 18 is insufficient, it may be possible to bond the entire circumference of the outer edge portion 18a of the filter 18 to at least either one of the first flange portion 32a and the second flange portion 31a. Thereby, the filter 18 may be held with a high holding force. Further, the sealing member 34 may be omitted.

A tubular discharge pipe 27 is arranged in the interior of the toner chamber 16, as illustrated in FIGS. 3A to 5. The discharge pipe 27 includes an inlet 27a that opens downward in the gravity direction G, and an outlet 27b that opens rearward, that is, upstream in the X direction, that communicates with the discharge port 16a of the toner cartridge C and that is passed through to the exterior of the toner cartridge C. The outlet 27b is positioned above the inlet 27a. The discharge pipe 27 includes a first pipe portion that extends in the Y direction or the gravity direction G and to which the inlet 27a is disposed, and a second pipe portion that extends in the X direction and to which the outlet 27b connected to the discharge port 16a is disposed, wherein the discharge pipe 27 is bend in midway. As described, the discharge pipe 27 connects the inlet 27a and the outlet 27b. The inlet 27a at an opposite end portion of the outlet 27b of the discharge pipe 27 is arranged to face the lowest portion 18b, which is the portion of the filter 18, with a gap therebetween in the gravity direction G. The discharge pipe 27 is composed arbitrary of a tube having flexibility formed of a resin material such as rubber or a silicon material, or a hollow member formed of a pipe made of resin or metal.

As illustrated in FIGS. 4 and 8, supporting portions 32b and 32c are extended from the inner circumferential surface of the first frame body 32. The supporting portion 32b extends in the −Y direction, i.e., the gravity direction G, from the inner circumferential surface of the upper surface side of the first frame body 32, and the supporting portion 32c extends in the X direction from the inner circumferential surface on the rear side of the first frame body. The supporting portions 32b and 32c respectively support the area of the discharge pipe 27 near the inlet 27a and the area thereof near the outlet 27b. The supporting portions 32b and 32c may be formed integrally with the first box portion of the first frame body 32 when forming the first frame body 32, or it may be formed as a separate member as the first box portion.

Hereafter, the toner cartridge CK that replenishes toner to the developer container 12K serving as a first developer container of the process cartridge BK and the toner cartridge CY that replenishes toner to the developer container 12Y serving as a second developer container of the process cartridge BY will be described. The developer container 12K includes the toner accommodating portion 12a serving as first toner accommodating portion. The developer container 12Y includes the toner accommodating portion 12a serving as second toner accommodating portion. The toner cartridge CK serving as a first cartridge includes the toner chamber 16 serving as a first toner chamber to which the discharge port 16a serving as a first discharge port is disposed, and the filter 18 serving as a first filter. Further, the toner cartridge CK includes the air chamber 17, which is the air chamber 17 adjacent to the toner chamber 16 via the filter 18 and which serves as a first air chamber to which is disposed the intake port 20 serving as a first intake port into which air is taken in from the exterior of the toner cartridge CK. Further, the toner cartridge CK includes the discharge pipe 27 which is disposed on the toner chamber 16, which extends from the inlet 27a serving as a first inlet to the outlet 27b serving as a first outlet, and which serves as a first pipe through which toner T passes.

Similarly, the toner cartridge CY that serves as a second cartridge includes the toner chamber 16 serving as a second toner chamber to which the discharge port 16a serving as a second discharge port is disposed, and the filter 18 serving as a second filter. Further, the toner cartridge CY includes the air chamber 17 which is arranged adjacent to the toner chamber 16 via the filter 18 and which serves as a second air chamber to which the intake port 20 serving as a second intake port is disposed. Further, the toner cartridge CY includes the discharge pipe 27, which is disposed on the toner chamber 16, which extends from the inlet 27a serving as a second inlet to the outlet 27b serving as a second outlet, and which serves as a second pipe through which toner T passes. The pump 35K (refer to FIG. 11) serving as a first pump is connected to the toner cartridge CK, and the pump 35Y (refer to FIG. 11) serving as a second pump is connected to the toner cartridge CY.

### Toner Conveyance Mechanism

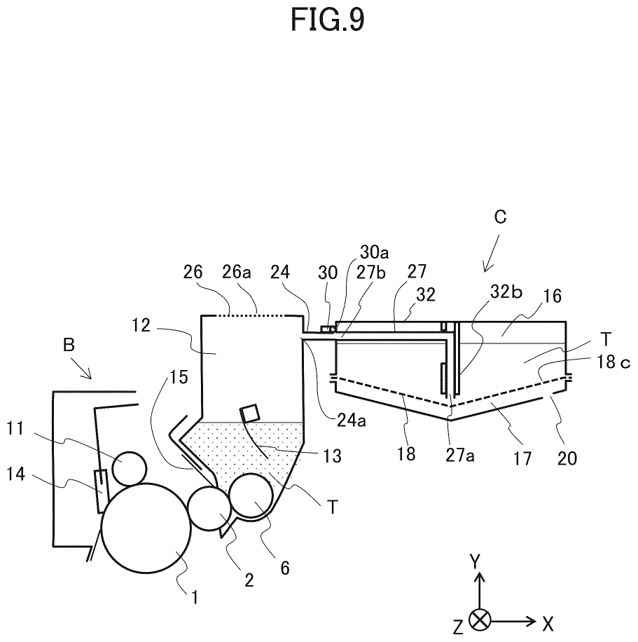

Next, a mechanism by which toner accommodated in the toner chamber 16 of the toner cartridge C is conveyed to the developer container 12 of the process cartridge B will be described with reference to FIGS. 1, 3A, 3B, and 9. FIG. 9 is a cross-sectional view illustrating a state in which the toner cartridge C is connected to the developer container 12 via the passage 24. As illustrated in FIGS. 1 and 9, air discharged from the pump 35 is taken into the air chamber 17 via the air supply pipe 21 and the intake port 20 of the toner cartridge C. Then, the air is filled in the air chamber 17 and passed through the filter 18 to flow into the toner chamber 16.

The air flown into the toner chamber 16 enters through particles of toner T and thereby fluidizes toner T. The interior of the toner cartridge C is set to positive pressure by the air flowing therein from the pump 35, and air attempts to exit to the exterior of the toner cartridge C through the discharge port 16a via the discharge pipe 27. In this state, toner T within the toner chamber 16 is caused to move together with air into the discharge pipe 27 through the discharge port 16a to be discharged to the exterior of the toner cartridge C. That is, the discharge pipe 27 guides toner within the toner chamber 16 together with air from the inlet 27a to the discharge port 16a.

By disposing the air chamber 17, which is an airtight space, between the pump 35 and the filter 18, as according to the present embodiment, the air being discharged from the pump 35 heads toward the filter 18 efficiently without being dispersed to the exterior of the toner cartridge C. For example, in a state where toner T within the toner chamber 16 of the toner cartridge C is aggregated, such as by being vibrated or being left as it is for a long time, a high pressure may be required to flow air through the filter 18 into the toner chamber 16. Even in such a case, by sending air continuously from the pump 35 into the air chamber 17 and increasing the pressure, i.e., air pressure, within the air chamber 17, air may be sent into the toner chamber 16 through the filter 18. Further, by disposing the air chamber 17, the pump 35 is only required to have an ability to generate enough pressure to send air continuously into the air chamber 17 until a necessary pressure is produced to allow air to pass through the filter 18 into the toner chamber 16. Therefore, the pump 35 is not required to realize a specific discharge rate or a discharge quantity, such that a small pump unit may be adopted, which contributes to downsizing the apparatus.

According further to the present embodiment, the only exit of air taken in through the intake port 20 to the toner cartridge C is the discharge port 16a. Therefore, the flow of air within the toner cartridge C is stabilized, and toner T accommodated in the toner chamber 16 can be discharged stably to the exterior of the toner cartridge.

Even further, by providing no ventilation hole or discharge port other than the single discharge port 16a to the toner cartridge C, discharge of toner T may be performed stably by only the force of the pump 35 discharging air toward the intake port 20. In a state where a plurality of air discharge ports are disposed, it becomes difficult to control the flow of toner and air, such that in order to convey toner stably, a configuration is required to suck in toner and air and to discharge the same to the exterior of the toner cartridge C. According to the present embodiment, toner T may be discharged stably without providing another pump for sucking in air, such that the conveyance of toner T may be realized stably by a simple configuration.

Toner T discharged from the discharge port 16a is replenished via the passage 24 to an upstream end portion of the developer container 12 in the Y direction. The agitating member 13 that agitates toner within the developer container 12 is disposed rotatably in the toner accommodating portion 12a of the developer container 12, as illustrated in FIG. 2.

Toner within the toner accommodating portion 12a is leveled by the rotation of the agitating member 13. In the present embodiment, the agitating member 13 is composed of the rotation shaft 13a and the agitating sheet 13b fixed to the rotation shaft 13a, but the present technique is not limited thereto. For example, the agitating member 13 may be composed of a screw configured to convey toner within the toner accommodating portion 12a of the developer container 12 along the Z direction.

Not only toner T but also air flows into the developer container 12, such that the internal pressure within the developer container 12 rises. Therefore, according to the present embodiment, as illustrated in FIGS. 3A, 3B, and 9, the opening 26 is formed on the upper surface of the developer container 12, and the opening 26 is covered by the filter 26a. Thereby, toner flowing into the developer container 12 is regulated from being discharged to the exterior by the filter 26a, and remains within the developer container 12. Meanwhile, at least a portion of air flown into the developer container 12 passes through the filter 26a and is discharged to the exterior of the developer container 12. Thereby, the rising of internal pressure of the developer container 12 is suppressed, and replenishment of toner to the developer container 12 may be performed smoothly.

As described above, toner accommodated in the toner cartridge C is conveyed together with air to the developer container 12 and replenished into the developer container 12. Since toner is conveyed using air, the freedom of design of the toner conveyance path is enhanced, and since there is no need for a member such as a screw for conveying toner, the number of components may be reduced and costs may be cut down.

Further, as described above, the inlet 27a of the discharge pipe 27 is arranged to face the lowest portion 18b of the filter 18 with a gap formed therebetween. The filter 18 is held at a position inclined downward toward the lowest portion 18b, such that when the remaining amount of toner within the toner chamber 16 is reduced, toner fluidized by air moves along the inclination of the filter 18 and gathers at the lowest portion 18b. In other words, toner within the toner chamber 16 may be guided toward the inlet 27a of the discharge pipe 27.

Therefore, even if the amount of toner remaining is the toner chamber 16 becomes small, toner gathered at the lowest portion 18b may be discharged from the inlet 27a of the discharge pipe 27 efficiently via the discharge port 16a to the exterior of the toner cartridge C. The discharge port 16a is arranged above the inlet 27a and the bottom surface portion 18e of the filter 18, and toner is conveyed by air from the inlet 27a to the discharge port 16a. Therefore, the amount of toner that remains within the toner chamber 16 without being replenished may be reduced.

### Transition of Toner Discharge State

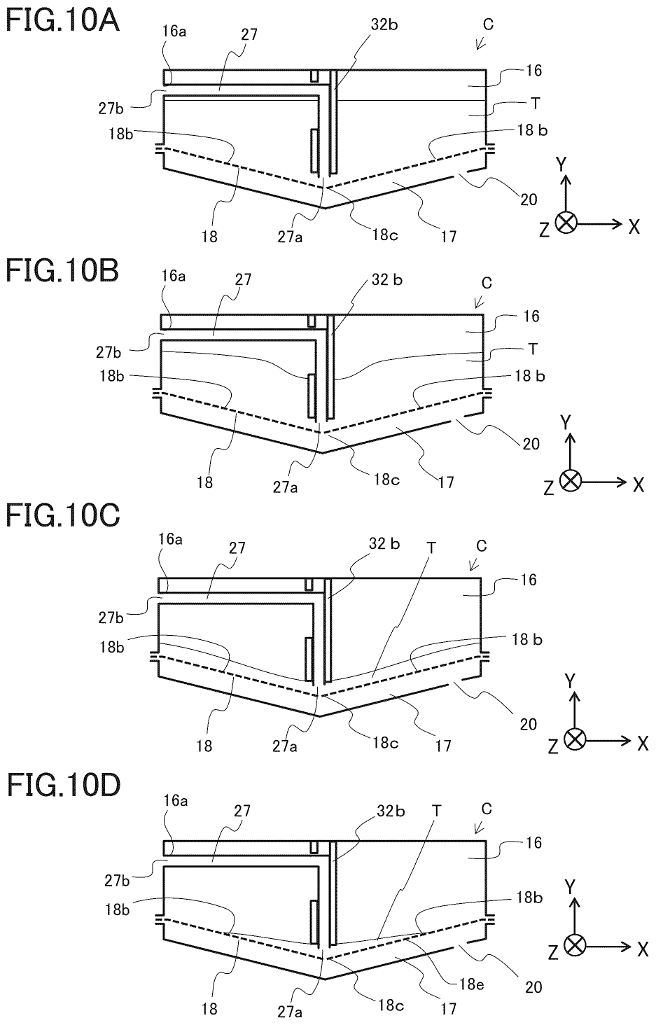

FIGS. 10A to 10D are each a cross-sectional view illustrating a transition of discharge state in a state where toner T accommodated in the toner chamber 16 is discharged from the toner cartridge C. FIG. 10A is a cross-sectional view illustrating a state in which the discharge of toner T is not started, and FIG. 10B is a cross-sectional view illustrating a state in which the discharge of toner T has been started by air being taken in through the intake port 20. FIG. 10C is a cross-sectional view illustrating a state in which toner T has been discharged further from the state of FIG. 10B, and FIG. 10D is a cross-sectional view illustrating a state in which the inclined portions 18c of the filter 18 are partially exposed. As illustrated in FIG. 10A, when air is sent into the air chamber 17 of the toner cartridge C through the intake port 20 by the pump 35, air flows toward the only exist of the toner cartridge C, which is the discharge port 16a, via the filter 18 and the discharge pipe 27. In this state, air is flown together with toner T, such that toner T enters the inlet 27a together with air, is conveyed through the discharge pipe 27 toward the discharge port 16a, and is discharged through the discharge port 16a. Thereby, toner T accommodated in the toner chamber 16 is reduced, and transition from the state of FIG. 10A to the state of FIG. 10B occurs.

As illustrated in FIG. 10B, when toner T within the toner chamber 16 is reduced through discharge of toner T, the agent surface of toner T in the vicinity of the inlet 27a lowers with respect to the gravity direction. Thereby, toner T accommodated in the toner chamber 16 starts to collapse from the circumference of the inlet 27a. In this state, since toner T is fluidized by the flowing in of air having passed through the filter 18, toner T is conveyed along the inclined surface of the inclined portions 18c toward the lowest portion 18b. In a state where flowing in of air from the intake port 20 is continued, toner T in the vicinity of the lowest portion 18b enters through the inlet 27a into the discharge pipe 27, is passed through the discharge pipe 27 together with air, and is discharged through the discharge port 16a. In a state where the discharge of toner T is performed continuously, the agent surface of toner T accommodated in the toner chamber 16 is further lowered, and transition occurs from the state of FIG. 10B to the state of FIG. 10C and further to the state of FIG. 10D.

As illustrated in FIG. 10D, when toner T in the toner accommodating portion 12a is reduced, a portion of the inclined portions 18c of the filter 18 is exposed. In this state, a ventilation amount of the filter 18 and a pump flow rate are set such that air discharged from the pump 35 is discharged through the entire surface of the bottom surface portion 18e of the filter 18, regardless of the presence of toner on the filter 18.

The inclination angle of the inclined portions 18c or the flow rate of air supplied from the pump 35 also affect the discharge property of toner T. It is effective to increase the angle of the inclined portions 18c to discharge toner T from the entire area of the toner chamber 16. However, if the angle of the inclined portions 18c is too large, the volume of toner T that may be accommodated in the toner chamber 16 will be reduced compared to a configuration where the angle of the inclined portions 18c is small. Then, it may be difficult to achieve downsizing of the toner cartridge C if a desired amount of toner T is to be accommodated. Therefore, from the viewpoint of ensuring capacity and downsizing of the toner cartridge C, it is preferable to set the angle of the inclined portions 18c as small as possible within the range in which discharge of toner T can be performed.

### Positioning of Discharge Pipe

As illustrated in FIGS. 3A and 3B, the first frame body 32 may position the discharge pipe 27 such that the inlet 27a faces the lowest portion 18b of the filter 18 by engaging the supporting portions 32b and 32c and the discharge pipe 27. The position of the inlet 27a within the toner chamber 16 with respect to the lowest portion 18b of the filter 18 affects the discharge property of toner T. As illustrated in FIGS. 10A to 10C, toner T accommodated in the toner chamber 16 fluidizes by the flowing in of air, and is conveyed toward the lowest portion 18b by the configuration of the inclined portions 18c. Therefore, according to the configuration of the present embodiment, it is most desirable from the viewpoint of discharge of toner T to dispose the inlet 27a in the vicinity of the lowest portion 18b.

For example, if the discharge pipe 27 is composed of a member having flexibility without disposing the supporting portions 32b and 32c within the toner chamber 16, the position of the inlet 27a may vary due to by stimulations such as impact or vibration applied to the toner cartridge C or by the movement of toner T. If the position of the inlet 27a is displaced from the vicinity of the lowest portion 18b, since the position in which toner T gathers most within the toner chamber 16 is the vicinity of the lowest portion 18b, the discharge amount of toner T may also vary.

Especially, as illustrated in FIG. 10C, if the position of the inlet 27a is moved to a position where there is only a small amount of is small T or where no toner T is present when the amount of toner T within the toner chamber 16 reduces, it becomes difficult to send toner T into the discharge pipe 27 even if air is taken in from the intake port 20. Then, the amount of toner T remaining within the toner chamber 16 may be increased compared to a state where the inlet 27a is positioned in the vicinity of the lowest portion 18b. That is, by positioning the inlet 27a reliably, toner T may be discharged stably from the toner cartridge C to the exterior. Further, the amount of toner T remaining in the toner chamber 16 may be controlled, and excessive toner T may be suppressed from remaining within the toner chamber 16 when toner T can no longer be discharge from the discharge port 16a by the flowing of air into the intake port 20.

### Control System

FIG. 11 is a block diagram illustrating a portion of a control system of the image forming apparatus IF. As illustrated in FIG. 11, the image forming apparatus IF includes a control unit 40. The control unit 40 includes a Central Processing Unit (CPU) 41, a Read Only Memory (ROM) 42, and a Random Access Memory (RAM) 43. The ROM 42 stores various programs, and the CPU 41 reads and executes the programs is the ROM 42. The RAM 43 is used as a work area of the CPU 41.

Pump driving units 36Y, 36M, 36C, and 36K are connected to the control unit 40, and the pumps 35Y, 35M, 35C, and 35K are respectively driven by the pump driving units 36Y, 36M, 36C, and 36K. In the present embodiment, the pumps 35Y, 35M, 35C, and 35K are composed of diaphragm pumps. The pump driving units 36Y, 36M, 36C, and 36K are respectively formed of a motor, a cam, and a crank, and the rotation of the motor is converted by the cam and the crank into reciprocating motion, and transmitted to each pump. Further, the pumps 35Y, 35M, 35C, and 35K constitute a pump portion 135. The control unit 40 can control the pump driving units 36Y, 36M, 36C, and 36K independently from each other, and can replenish toner of an arbitrary color at an arbitrary timing.

### Actual Configuration of Passage

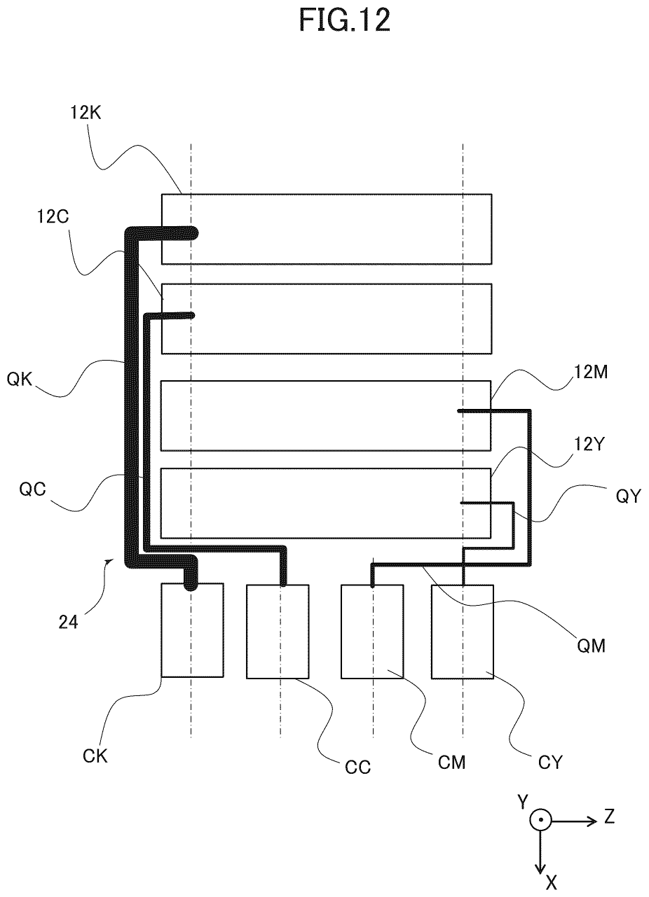

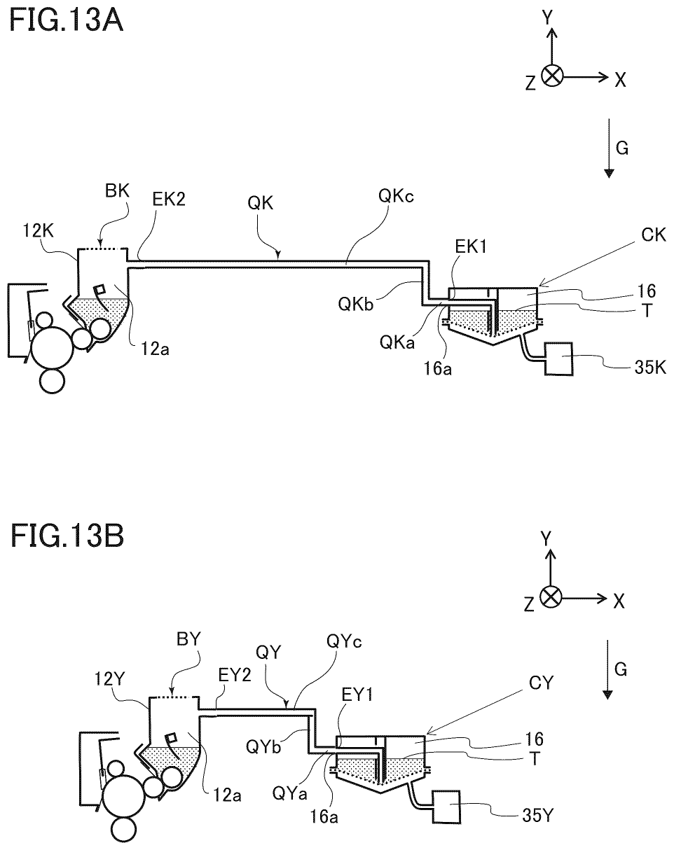

Next, an actual configuration of the passage 24 connecting the toner cartridge C and the process cartridge B will be described with reference to FIGS. 12, 13A, and 13B. FIG. 12 is a plan view illustrating toner conveyance paths QY, QM, QC, and QK. FIG. 13A is a front view of the toner conveyance path QK through which black toner passes, and FIG. 13B is a front view of the toner conveyance path QY through which yellow toner passes. In the above description, the toner cartridge C and the developer container 12 of the process cartridge B were connected by the passage 24, whereas according to the present embodiment, there are four toner cartridges C and four process cartridges B, i.e., developer containers 12, provided. Further, the passage 24 includes a plurality of toner conveyance paths QY, QM, QC, and QK respectively connecting the four toner cartridges and four developer containers. In the following description, the developer container of the process cartridge BY is referred to as the developer container 12Y, and the developer container of the process cartridge BM is referred to as the developer container 12M. Further, the developer container of the process cartridge BC is denoted as the developer container 12C, and the developer container of the process cartridge BK is denoted as the developer container 12K.

As illustrated in FIG. 12, the toner cartridge CY and the developer container 12Y are connected by the toner conveyance path QY. The toner cartridge CM and the developer container 12M are connected by the toner conveyance path QM. The toner cartridge CC and the developer container 12C are connected by the toner conveyance path QC. The toner cartridge CK and the developer container 12K are connected by the toner conveyance path QK. Through the toner conveyance paths QY, QM, QC, and QK, toner T of respective colors are conveyed together with air from the toner cartridges CY, CM, CC, and CK to the developer containers 12Y, 12M, 12C, and 12K.

In the present embodiment, the toner cartridges CY, CM, CC, and CK are aligned in the X direction, and the developer containers 12Y, 12M, 12C, and 12K are aligned in the Z direction upstream of the toner cartridges CY, CM, CC, and CK in the X direction. That is, the toner cartridges CY, CM, CC, and CK and the developer containers 12Y, 12M, 12C, and 12K are aligned along a same XZ plane, which is a horizontal plane. The toner conveyance paths QY, QM, QC, and QK mainly extend along the horizontal direction.

In the toner conveyance paths QY, QM, QC, and QK that mainly extend along the horizontal direction, toner conveyance force reduces as the distance between the toner cartridge C and the developer container 12 elongates. If the toner conveyance force of toner of the respective colors mutually differ, replenishment of toner to the developer container corresponding to the color toner having a low toner conveyance force may not be performed in time. Especially in a print job having a large image area, replenishment of toner to the developer container may not be performed in time. Further, the developer container corresponding to the color toner having a high toner conveyance force may become full, and toner may overflow from the developer container.

If the type of the pumps 35 attached to the toner cartridges of respective colors or the type of the pump driving units 36 for driving the respective pumps 35 are changed to compensate for the difference in toner conveyance force of different toner colors, the configuration of the apparatus will become complex, and costs will be increased. Therefore, according to the present embodiment, the differences of toner conveyance forces of different toner colors are reduced by varying the inner diameters of the toner conveyance paths QY, QM, QC, and QK having different lengths.

As illustrated in FIG. 12, the toner conveyance paths QY, QM, QC, and QK are flexible cylindrical tubes that are bendable. The lengths of the toner conveyance paths QY, QM, QC, and QK become longer in the order of toner conveyance paths QY, QM, QC, and QK.

More specifically, as illustrated in FIG. 13A, the toner conveyance path QK through which black toner serving as a first toner passes includes, for example, a first passage QKa, a second passage QKb, and a third passage QKc. The first passage QKa includes a first end EK1 connected to the discharge port 16a of the toner cartridge C, and extends upstream in the X direction, that is, in the horizontal direction, from the first end EK1. The second passage QKb extends in the Y direction, that is, in the vertical direction, from the first passage QKa. The third passage QKc extends upstream in the X direction, that is, in the horizontal direction, from the upper end of the second passage QKb, and includes a second end EK2 connected to the developer container 12K of the process cartridge BK. In other words, the first end EK1 communicates with an interior of the toner cartridge CK, and the second end EK2 communicates with the toner accommodating portion 12a of the developer container 12K. The toner conveyance path QK extends from the first end EK1 to the second end EK2.

As illustrated in FIG. 13B, the toner conveyance path QY through which yellow toner serving as a second toner passes includes, for example, a first passage QYa, a second passage QYb, and a third passage QYc. The first passage QYa includes a third end EY1 connected to the discharge port 16a of the toner cartridge C, and extends upstream in the X direction, that is, in the horizontal direction, from the third end EY1. The second passage QYb extends in the Y direction, that is, in the vertical direction, from the first passage QYa. The third passage QYc extends upstream in the X direction, that is, in the horizontal direction, from the upper end of the second passage QYb, and includes a fourth end EY2 connected to the developer container 12Y of the process cartridge BY. In other words, the third end EY1 communicates with an interior of the toner cartridge CY, and the fourth end EY2 communicates with the toner accommodating portion 12a of the developer container 12Y. The toner conveyance path QY extends from the third end EY1 to the fourth end EY2.

As illustrated in FIG. 13A, the total length of the first passage QKa and the third passage QKc that are portions extending in the horizontal direction is longer than half the length from the first end EK1 to the second end EK2 of the toner conveyance path QK. As illustrated in FIG. 13B, the total length of the first passage QYa and the third passage QYc that are portions extending in the horizontal direction is longer than half the length from the first end EY1 to the second end EY2 of the toner conveyance path QY. The first passage QKa and third passage QKc and the first passage QYa and third passage QYc do not necessarily have to extend in the horizontal direction. For example, the first passage QKa and third passage QKc and the first passage QYa and third passage QYc may be disposed to extend, in the direction in which toner is conveyed, in a downwardly inclined direction or an upwardly inclined direction at an angle of 45 degrees or less with respect to the horizontal direction.

Further, although not illustrated in detail, the portions of the toner conveyance paths QM and QC that extend along the horizontal direction are also both longer than half the entire length of each of the toner conveyance paths QM and QC. According to the toner conveyance paths QY, QM, QC, and QK configured as above, according to the present embodiment, the inner diameters of the toner conveyance paths QY, QM, QC, and QK are set to become larger in the order of toner conveyance paths QY, QM, QC, and QK.

That is, in a state where the lengths of the toner conveyance paths QY, QM, QC, and QK are referred to as L1Y, L1M, L1C, and L1K, and the inner diameters of the toner conveyance paths QY, QM, QC, and QK are referred to as D1Y, D1M, D1C, and D1K, these lengths and inner diameters satisfy the following relational expressions.

$$L 1 Y < L 1 M < L 1 C < L 1 K \qquad ( 1 )$$

$$D 1 Y < D 1 M < D 1 C < D 1 K \qquad ( 2 )$$

Since the inner circumferential surfaces of the toner conveyance paths QY, QM, QC, and QK according to the present embodiment respectively have true circular shapes, cross-sectional areas A1Y, A1M, A1C, and A1K of the interior spaces of the toner conveyance paths QY, QM, QC, and QK satisfy the following relational expression.

$$A 1 Y < A 1 M < A 1 C < A 1 K \qquad ( 3 )$$

As described above, regarding the toner conveyance paths QY, QM, QC, and QK that extend along the horizontal direction, the toner conveyance force drops as the distance between the toner cartridge C and the developer container 12 elongates. Therefore, the toner conveyance paths QY, QM, QC, and QK having longer lengths are designed to have larger inner diameters, i.e., cross-sectional areas, by which pressure losses in the toner conveyance paths QY, QM, QC, and QK may be levelled. Therefore, toner conveyance forces of toner of respective colors may be uniformized, and toner conveyance amounts of respective colors may be stabilized.

For example, a length L1K, which is the length from the first end EK1 to the second end EK2 of the toner conveyance path QK serving as a first tube is longer than a length L1Y, which is the length from the third end EY1 to the fourth end EY2 of the toner conveyance path QY serving as a second tube. In this state, the cross-sectional area AIK of the interior space of the toner conveyance path QK is larger than the cross-sectional area A1Y of the interior space of the toner conveyance path QY. This is because the inner diameter D1K of the toner conveyance path QK is larger than the inner diameter D1Y of the toner conveyance path QY.

Thereby, the same type of pump may be used for the four pumps 35 that convey toner of four colors, and the pumps may be controlled appropriately by the same pump driving unit 36. Therefore, the costs of the image forming apparatus IF may be cut down. Further, since the inner diameters of the toner conveyance paths QY, QM, QC, and QK respectively differ, the toner conveyance paths QY, QM, QC, and QK may be respectively easily identified, such that assembling errors when assembling the toner conveyance paths QY, QM, QC, and QK may be reduced.

### Second Embodiment

Next, a second embodiment of the present disclosure will be described, wherein according to the second embodiment, the toner conveyance paths QY, QM, QC, and QK of the first embodiment are extended along the vertical direction, i.e., gravity direction. Therefore, components similar to the first embodiment are either not shown or denoted with the same reference numbers.

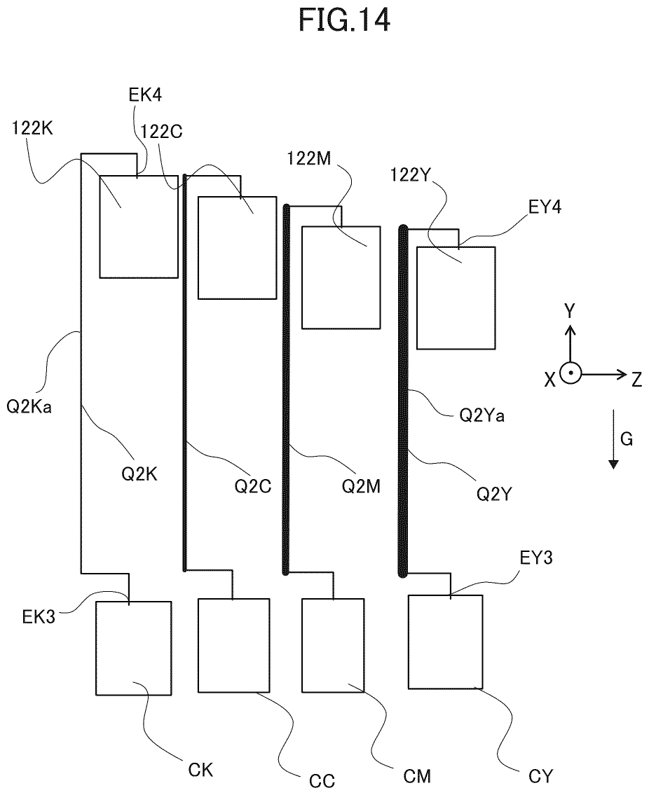

FIG. 14 is a front view illustrating toner conveyance paths Q2Y, Q2M, Q2C, and Q2K according to the second embodiment. In the present embodiment, the toner cartridges CY, CM, CC, and CK are aligned in the X direction, and developer containers 122Y, 122M, 122C, and 122K are also aligned in the X direction. Further, the developer containers 122Y, 122M, 122C, and 122K are arranged from down to up in the vertical direction, i.e., Y direction, in the order of developer containers 122Y, 122M, 122C, and 122K. That is, the toner cartridges CY, CM, CC, and CK and the developer containers 122Y, 122M, 122C, and 122K are arranged along a same YZ plane, which is a vertical plane. The toner conveyance paths Q2Y, Q2M, Q2C, and Q2K extend along the gravity direction G.

As illustrated in FIG. 14, the toner conveyance path Q2K through which black toner passes includes a first end EK3 that communicates with an interior of the toner cartridge CK, and a second end EK4 that communicates with a toner accommodating portion of the developer container 122K, and extends from the first end EK3 to the second end EK4. The toner conveyance path Q2K includes a perpendicular portion Q2Ka that extends in the Y direction, which is the upper direction opposite to the gravity direction G, with respect to a direction in which the black toner is conveyed.

The toner conveyance path Q2Y through which yellow toner passes includes a third end EY3 that communicates with an interior of the toner cartridge CY, and a fourth end EY4 that communicates with the toner accommodating portion of the developer container 122Y, and extends from the third end EY3 to the fourth end EY4. Further, the toner conveyance path Q2Y includes a perpendicular portion Q2Ya that extends in the Y direction with respect to a direction in which the yellow toner is conveyed.

A length of the perpendicular portion Q2Ka which is the portion extending in the Y direction, i.e., vertical direction, is longer than half the length from the first end EK3 to the second end EK4 of the toner conveyance path Q2K. Further, a length of the perpendicular portion Q2Ya which is the portion extending in the Y direction, i.e., vertical direction, is longer than half the length from the third end EY3 to the fourth end EY4 of the toner conveyance path Q2Y. The perpendicular portions Q2Ka and Q2Ya are not necessarily extended in the Y direction, i.e., vertical direction. For example, the perpendicular portions Q2Ka and Q2Ya may be disposed to extend, in the direction in which toner is conveyed, in the upwardly inclined direction or the downwardly inclined direction at an angle of 45 degrees or less with respect to the horizontal direction.

Although the description thereof is omitted, the portions of the toner conveyance paths Q2M and Q2C that extend along the Y direction are also longer than half the lengths of the respective toner conveyance paths Q2M and Q2C.

When conveying toner T upward in the vertical direction along the toner conveyance paths Q2Y, Q2M, Q2C, and Q2K, the necessary pressure for lifting toner T increases according to the toner amount. Therefore, the necessary pressure for conveying toner increases as the length of the toner conveyance path in the vertical direction elongates. According to the present embodiment, by varying the respective inner diameters of the toner conveyance paths Q2Y, Q2M, Q2C, and Q2K, it becomes possible to adjust the pressure necessary for conveying toner and to reduce the differences between the toner conveyance forces of toners of respective colors.

As illustrated in FIG. 14, the toner conveyance paths Q2Y, Q2M, Q2C, and Q2K are respectively composed of flexible cylindrical tubes that are bendable. The lengths of the toner conveyance paths Q2Y, Q2M, Q2C, and Q2K becomes shorter in the order of toner conveyance paths Q2Y, Q2M, Q2C, and Q2K. According to the present embodiment, the inner diameters of the toner conveyance paths Q2Y, Q2M, Q2C, and Q2K become larger in the order of toner conveyance paths Q2Y, Q2M, Q2C, and Q2K.

That is, in a state where the lengths of the toner conveyance paths Q2Y, Q2M, Q2C, and Q2K are referred to as L2Y, L2M, L2C, and L2K, and the inner diameters of the toner conveyance paths Q2Y, Q2M, Q2C, and Q2K are referred to as D2Y, D2M, D2C, and D2K, these lengths and inner diameters satisfy the following relational expressions.

$$L 2 Y < L 2 M < L 2 C < L 2 K \qquad ( 4 )$$

$$D 2 Y > D 2 M > D 2 C > D 2 K \qquad ( 5 )$$

Since the inner circumferential surfaces of the toner conveyance paths Q2Y, Q2M, Q2C, and Q2K according to the present embodiment respectively have true circular shapes, cross-sectional areas A2Y, A2M, A2C, and A2K of the interior spaces of the toner conveyance paths Q2Y, Q2M, Q2C, and Q2K satisfy the following relational expression.

$$A 2 Y > A 2 M > A 2 C > A 2 K \qquad ( 6 )$$

As described above, in the toner conveyance paths Q2Y, Q2M, Q2C, and Q2K that extend along the gravity direction G, the pressure required for conveying toner increases as the distance between the toner cartridge C and the process cartridge B elongates. Therefore, by reducing the inner diameter, i.e., cross-sectional area, for longer toner conveyance paths Q2Y, Q2M, Q2C, and Q2K, the pressure losses in the toner conveyance paths Q2Y, Q2M, Q2C, and Q2K may be levelled. Therefore, the toner conveyance forces of toners of respective colors may be uniformized, and the toner conveyance amounts of respective colors may be stabilized.

For example, the length L2K which is the length from the first end EK3 to the second end EK4 of the toner conveyance path Q2K serving as the first tube is longer than the length L2Y which is the length from the third end EY3 to the fourth end EY4 of the toner conveyance path Q2Y serving as the second tube. In this state, the cross-sectional area A2K of the interior space of the toner conveyance path Q2K is smaller than the cross-sectional area A2Y of the interior space of the toner conveyance path Q2Y. This is because the inner diameter D2K of the toner conveyance path Q2K is smaller than the inner diameter D2Y of the toner conveyance path Q2Y.

### Third Embodiment

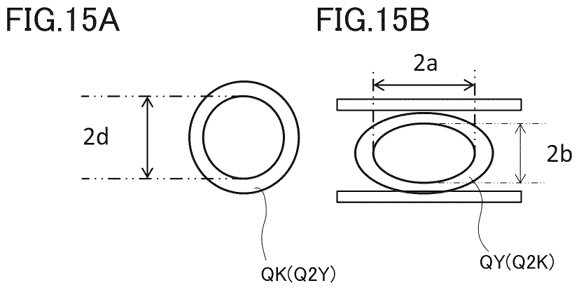

Next, a third embodiment of the present disclosure will be described, wherein according to the third embodiment, the toner conveyance paths of the first and second embodiments are modified. Therefore, components similar to the first embodiment are either not shown or denoted with the same reference numbers. FIG. 15A is a cross-sectional view of a toner conveyance path having a true circular cross-sectional shape. FIG. 15B is a cross-sectional view of a toner conveyance path having an elliptical cross-sectional shape.

The toner conveyance path illustrated in FIG. 15A has an inner diameter 2d, and the toner conveyance path illustrated in FIG. 15B has an elliptical shape in which the toner conveyance path of the inner diameter 2d illustrated in FIG. 15A is compressed unidirectionally into an elliptical shape. The toner conveyance path illustrated in FIG. 15B has an elliptical interior space shape with a length of the long axis set to a length 2a and a length of a short axis set to a length 2b.

In this state, in order to consider pressure losses in the toner conveyance path illustrated in FIG. 15B having the elliptical cross-sectional shape, a hydraulic diameter, i.e., equivalent diameter, Dh corresponding to the round shape of the toner conveyance path of FIG. 15B satisfies the following expression.

$$c = ( a - b ) / ( a + b )$$

$$Dh = 4 ab / ( a + b ) ( 64 - 16 c \hat{} 2 ) / 64 - 3 c \hat{} 4 )$$

For example, the hydraulic diameter of the toner conveyance path illustrated in FIG. 15B having deformed the toner conveyance path illustrated in FIG. 15A having a diameter of 4 mm such that the length of the long axis is set to 5 mm and the length of the short axis is set to 3 mm will be Dh=3.69 mm. That is, the toner conveyance path illustrated in FIG. 15B has a smaller cross-sectional area of the interior space thereof than the toner conveyance path illustrated in FIG. 15A, such that a state is realized which is equivalent to a state where the inner diameter is narrowed.

Therefore, for example, the toner conveyance path having a true circular cross-sectional shape illustrated in FIG. 15A may be applied to the toner conveyance path QK of the first embodiment illustrated in FIG. 12 or the toner conveyance path Q2Y of the second embodiment illustrated in FIG. 14. In this state, the toner conveyance path having an elliptical cross-sectional shape illustrated in FIG. 15B may be applied to the toner conveyance path QY of the first embodiment illustrated in FIG. 12 or the toner conveyance path Q2K of the second embodiment illustrated in FIG. 14. That is, the toner conveyance paths QK and QY are each formed of a tube having the same inner diameter 2d and having flexibility, wherein the toner conveyance path QK has a round cross-sectional shape and the toner conveyance path QY is deformed to have an elliptical cross-sectional shape. Similarly, the toner conveyance paths Q2K and Q2Y are each formed of a tube having the same the inner diameter 2d and having flexibility, wherein the toner conveyance path Q2Y has a round cross-sectional shape and the toner conveyance path Q2K is deformed to have an elliptical cross-sectional shape.

Thereby, the inner diameters of the toner conveyance paths being used may be unified such that components may be made common, and the pressure losses in the toner conveyance paths of respective colors may be levelled while cutting down costs. Further, the toner conveyance path having an elliptical cross-sectional shape may have the cross-sectional area of the interior space thereof adjusted by the amount in which the toner conveyance path is collapsed, such that the toner conveyance forces of toners of respective colors may be uniformized easily and inexpensively, and the toner conveyance amount of the respective colors may be stabilized.

### Fourth Embodiment

Next, a fourth embodiment of the present disclosure will be described, wherein according to the fourth embodiment, the lengths and inner diameters of the toner conveyance paths QY, QM, QC, and QK of the first embodiment are modified to be the same. Therefore, components similar to the first embodiment are either not shown or denoted with the same reference numbers.

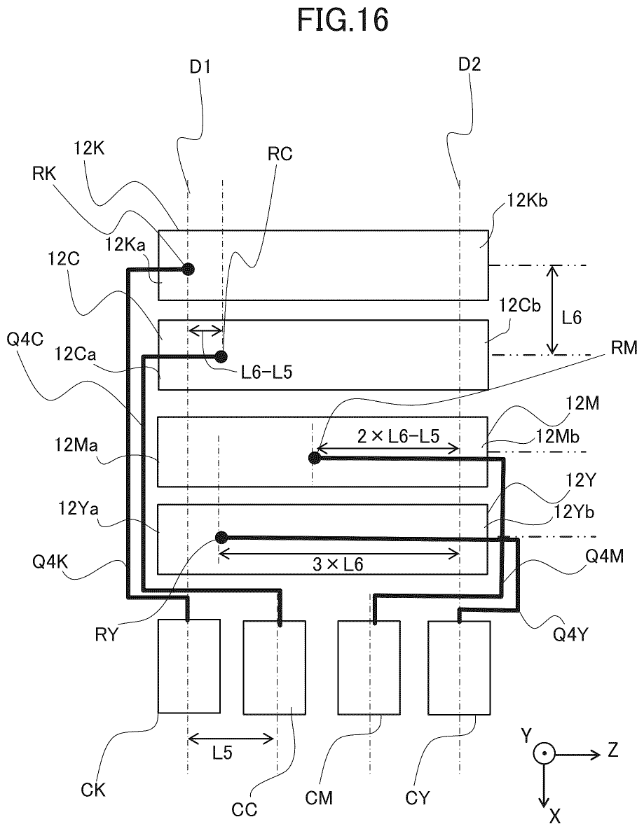

FIG. 16 is a plan view illustrating toner conveyance paths Q4Y, Q4M, Q4C, and Q4K according to the fourth embodiment. The toner conveyance paths Q4Y, Q4M, Q4C, and Q4K according to the present embodiment extend along the horizontal direction, similar to the first embodiment. Further, the toner conveyance paths Q4Y, Q4M, Q4C, and Q4K are respectively composed of tubes having the same inner diameter.

The toner conveyance path Q4K serving as a first tube that connects the toner cartridge CK and the developer container 12K is connected to the developer container 12K at a point RK. The toner conveyance path Q4C that connects the toner cartridge CC and the developer container 12C is connected to the developer container 12C at a point RC. The toner conveyance path Q4M that connects the toner cartridge CM and the developer container 12M is connected to the developer container 12M at a point RM. The toner conveyance path Q4Y serving as a second tube that connects the toner cartridge CY and the developer container 12Y is connected to the developer container 12Y at a point RY.

The developer containers 12Y, 12M, 12C, and 12K according to the present embodiment are arranged in the X direction at intervals of a distance L6, and the toner cartridges CY, CM, CC, and CK are arranged in the Z direction at intervals of a distance L5. The developer containers 12Y, 12M, 12C, and 12K respectively include first end portions 12Ya, 12Ma, 12Ca, and 12Ka and second end portions 12Yb, 12Mb, 12Cb, and 12Kb in the Z direction. A position downstream for a predetermined distance from the first end portions 12Ya, 12Ma, 12Ca, and 12Ka in the Z direction is referred to as a position D1, and a position upstream for a predetermined distance from the second end portions 12Yb, 12Mb, 12Cb, and 12Kb in the Z direction is referred to as a position D2. In other words, the positions D1 and D2 are each at a position respectively shifted for a same distance from the first end portions 12Ya, 12Ma, 12Ca, and 12Ka and the second end portions 12Yb, 12Mb, 12Cb, and 12Kb.

In the present embodiment, the entire lengths of the toner conveyance paths Q4Y, Q4M, Q4C, and Q4K are set to be mutually equal so as to level the pressure losses in the toner conveyance paths Q4Y, Q4M, Q4C, and Q4K. Therefore, the point RK is positioned at the same position as the position D1 in the Z direction, and the point RC is positioned at a position shifted downstream for a distance (L6−L5) from the position D1 in the Z direction. The point RM is positioned at a position shifted upstream for a distance (2×L6−L5) from the position D2 in the Z direction, and the point RY is positioned at a position shifted upstream for a distance (3×L6) from the position D2 in the Z direction.

According further to the present embodiment, the toner conveyance paths Q4C and Q4K are arranged to respectively pass the first end portions 12Ca and 12Ka, i.e., first end portion and third end portion, when viewed in the gravity direction, i.e., −Y direction. The toner conveyance paths Q4Y and Q4M are arranged to respectively pass the second end portions 12Yb and 12Mb, i.e., second end portion and fourth end portion, when viewed in the gravity direction, i.e., −Y direction. Thereby, the toner conveyance paths Q4Y, Q4M, Q4C, and Q4K may be arranged in a compact manner, and by suppressing the total lengths of the toner conveyance paths Q4Y, Q4M, Q4C, and Q4K, the pump portion 135 may be downsized.

By arranging the toner conveyance paths Q4Y, Q4M, Q4C, and Q4K as described above, the entire lengths of the toner conveyance paths Q4Y, Q4M, Q4C, and Q4K may be made equal. Therefore, the pressure losses in the toner conveyance paths Q4Y, Q4M, Q4C, and Q4K may be levelled, the toner conveyance forces of toners of respective colors may be uniformized, and the toner conveyance amounts of the respective colors may be stabilized.

Thereby, the same type of pump may be adopted for the four pumps 35 for conveying toners of four colors, and the pumps may be controlled appropriately using the same pump driving unit 36. Further, common components may be used for the toner conveyance paths Q4Y, Q4M, Q4C, and Q4K, such that costs may be cut down, and assembling errors when assembling the toner conveyance paths Q4Y, Q4M, Q4C, and Q4K may be reduced.

### Fifth Embodiment

Next, a fifth embodiment of the present disclosure will be described, wherein according to the fifth embodiment, the arrangements of the toner conveyance paths Q4Y, Q4M, Q4C, and Q4K of the fourth embodiment are modified. Therefore, components similar to the fourth embodiment are either not shown or denoted with the same reference numbers.

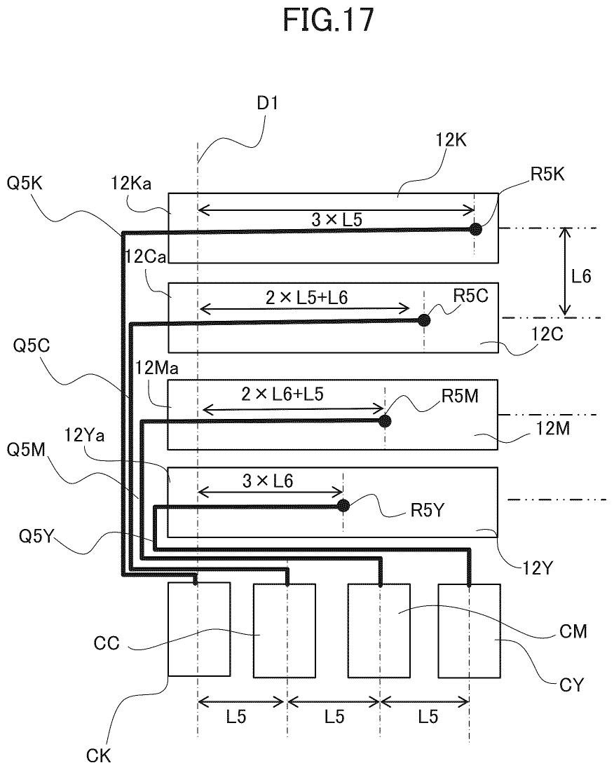

FIG. 17 is a plan view illustrating toner conveyance paths Q5Y, Q5M, Q5C, and Q5K according to the fifth embodiment. The toner conveyance paths Q5Y, Q5M, Q5C, and Q5K according to the present embodiment are extended along the horizontal direction, similar to the first and fourth embodiments. The toner conveyance paths Q5Y, Q5M, Q5C, and Q5K are each formed of a tube having the same inner diameter.

The toner conveyance path Q5K serving as a first tube that connects the toner cartridge CK and the developer container 12K is connected to the developer container 12K at a point R5K. The toner conveyance path Q5C that connects the toner cartridge CC and the developer container 12C is connected to the developer container 12C at a point R5C. The toner conveyance path Q5M serving as a second tube that connects the toner cartridge CM and the developer container 12M is connected to the developer container 12M at a point R5M. The toner conveyance path Q5Y that connects the toner cartridge CY and the developer container 12Y is connected to the developer container 12Y at a point R5Y.

According to the present embodiment, similar to the fourth embodiment, the entire lengths of the toner conveyance paths Q5Y, Q5M, Q5C, and Q5K are set to be mutually equal so as to level the pressure losses in the toner conveyance paths Q5Y, Q5M, Q5C, and Q5K. Therefore, the point R5K is positioned at a position shifted downstream for a distance (3×L5) from the position D1 in the Z direction, and the point R5C is positioned at a position shifted downstream for a distance (2×L5+L6) from the position D1 in the Z direction. The point R5M is positioned at a position shifted downstream for a distance (2×L6+L5) from the position D1 in the Z direction, and the point R5Y is positioned at a position shifted downstream for a distance (3×L6) from the position D1 in the Z direction.

According further to the present embodiment, the toner conveyance paths Q5Y, Q5M, Q5C, and Q5K are arranged to respectively pass the first end portions 12Ya, 12Ma, 12Ca, and 12Ka when viewed in the gravity direction, i.e., −Y direction. Therefore, the toner conveyance paths Q5Y, Q5M, Q5C, and Q5K may be assembled or subjected to maintenance from the first end side of the developer containers 12Y, 12M, 12C, and 12K, such that the workability may be improved.

By arranging the toner conveyance paths Q5Y, Q5M, Q5C, and Q5K as described above, the entire lengths of the toner conveyance paths Q5Y, Q5M, Q5C, and Q5K may be made equal. Therefore, the pressure losses in the toner conveyance paths Q5Y, Q5M, Q5C, and Q5K may be levelled. Therefore, the toner conveyance forces of toners of respective colors may be uniformized, and the toner conveyance amounts of the respective colors may be stabilized.

Thereby, the same type of pump may be adopted for the four pumps 35 for conveying toners of four colors, and the pumps may be controlled appropriately using the same pump driving unit 36. Further, common components may be used for the toner conveyance paths Q5Y, Q5M, Q5C, and Q5K, such that costs may be cut down, and assembling errors when assembling the toner conveyance paths Q5Y, Q5M, Q5C, and Q5K may be reduced.

### Sixth Embodiment

Next, a sixth embodiment of the present disclosure will be described, wherein according to the sixth embodiment, the shapes of the toner conveyance paths Q2Y, Q2M, Q2C, and Q2K of the second embodiment are modified. Therefore, components similar to the second embodiment are either not shown or denoted with the same reference numbers. Specifically, in the following description, a toner conveyance path Q6Y that connects the toner cartridge CY serving as a cartridge and the developer container 122Y of the process cartridge BY will be described. Other toner conveyance paths Q6M, Q6C, and Q6K connected to the toner cartridges CM, CC, and CK may also have similar configurations as the toner conveyance path Q6Y.

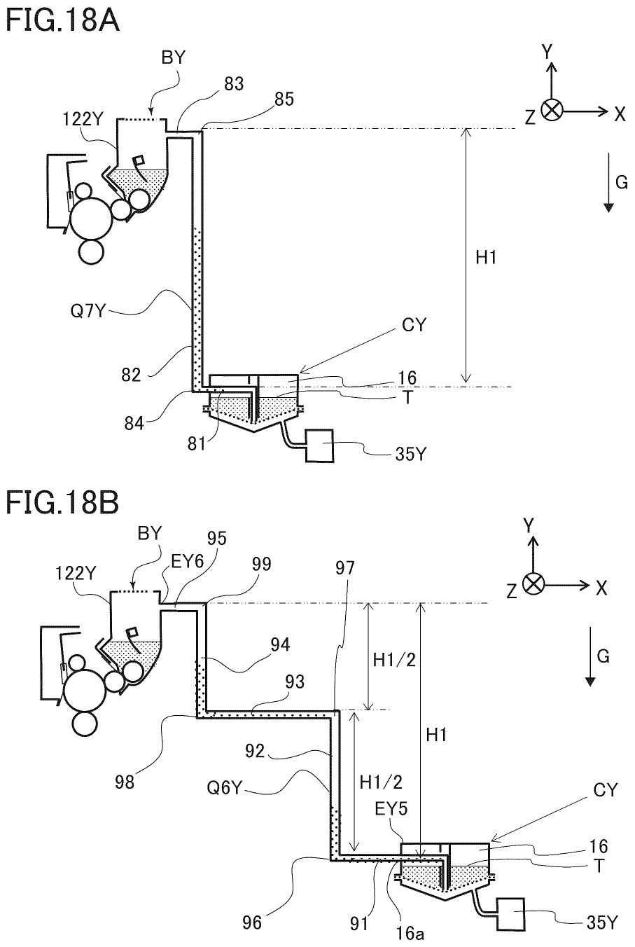

FIG. 18A is a schematic view of a toner conveyance path Q7Y serving as a comparative example. FIG. 18B is a schematic view of the toner conveyance path Q6Y according to the sixth embodiment. As illustrated in FIGS. 18A and 18B, the developer container 122Y of the process cartridge BY is arranged above the toner cartridge C. As illustrated in FIG. 18A, the toner conveyance path Q7Y according to the comparative example connects the toner cartridge CY and the developer container 122Y, and includes a first horizontal portion 81, a perpendicular portion 82, a second horizontal portion 83, an upward bent portion 84, and a horizontally bent portion 85.

The first horizontal portion 81 and the second horizontal portion 83 are extended in the horizontal direction, for example, in the X direction. The perpendicular portion 82 is extended in the vertical direction, that is, in the Y direction. The upward bent portion 84 is disposed between the first horizontal portion 81 and the perpendicular portion 82, and bends the toner conveyance path Q7Y upward. The horizontally bent portion 85 is disposed between the perpendicular portion 82 and the second horizontal portion 83, and bends the toner conveyance path Q7Y in the horizontal direction, such as toward the upstream side in the X direction.

In a state where the pump 35Y stops after toner T has been conveyed from the toner cartridge CY illustrated in FIG. 18A via the toner conveyance path Q7Y to the developer container 122Y of the process cartridge BY, toner T will remain within the toner conveyance path Q7Y. Specifically, toner T will accumulate at the lower portion of the perpendicular portion 82, that is, at the upward bent portion 84, by gravity. Further, toner T within the first horizontal portion 81 and the second horizontal portion 83 will accumulate on the spot.

Next, in a state where the pump 35Y is restarted and air is started to be supplied to the toner conveyance path Q7Y again, air is first supplied to toner T accumulated in the upward bent portion 84. Then, when air and toner T are gradually mixed, bulk density of toner T drops, and toner T is conveyed together with air to the developer container 122Y of the process cartridge BY. In a state where the amount of toner T accumulated in the upward bent portion 84 according to the comparative example is referred to as an amount V, a maximum pressure required for toner conveyance in the toner conveyance path Q7Y is referred to as a pressure P1.

Meanwhile, as illustrated in FIG. 18B, the toner conveyance path Q6Y according to the present embodiment includes a first end EY5 that communicates with an interior of the toner cartridge CY and a second end EY6 that communicates with a toner accommodating portion of the developer container 122Y, and extends from the first end EY5 to the second end EY6. Further, the toner conveyance path Q6Y includes a first horizontal portion 91, a first perpendicular portion 92, a second horizontal portion 93, a second perpendicular portion 94, a third horizontal portion 95, a first upward bent portion 96, a first horizontally bent portion 97, a second upward bent portion 98, and a second horizontally bent portion 99.

The first horizontal portion 91, the second horizontal portion 93, and the third horizontal portion 95 are extended in the horizontal direction, such as in the X direction. The first perpendicular portion 92 and the second perpendicular portion 94 are extended in the vertical direction, that is, in the Y direction. The first horizontal portion 91 serving as a fourth portion is disposed between the first end EY5 and the first perpendicular portion 92. The first perpendicular portion 92 serving as a first portion is disposed between the first horizontal portion 91 and the second horizontal portion 93. The second horizontal portion 93 serving as a third portion is disposed between the first perpendicular portion 92 and the second perpendicular portion 94. The third horizontal portion 95 serving as a fifth portion is disposed between the second perpendicular portion 94 and the second end EY6. In the present embodiment, a length of each of the first perpendicular portion 92 and the second perpendicular portion 94 is shorter than a length of the second horizontal portion 93.

The first upward bent portion 96 serving as a first bent portion is disposed between the first horizontal portion 91 and the first perpendicular portion 92, and bends the toner conveyance path Q6Y serving as a tube upward. The first horizontally bent portion 97 is disposed between the first perpendicular portion 92 and the second horizontal portion 93, and bends the toner conveyance path Q6Y in the horizontal direction, for example, upstream in the X direction. Unlike the first upward bent portion 96, the second upward bent portion 98 serving as a second bent portion is disposed between the second horizontal portion 93 and the second perpendicular portion 94, and bends the toner conveyance path Q6Y upward. The second horizontally bent portion 99 is disposed between the second perpendicular portion 94 and the third horizontal portion 95, and bends the toner conveyance path Q6Y in the horizontal direction, for example, upstream in the X direction.

According to the present embodiment, the first perpendicular portion 92 and the second perpendicular portion 94 are extended in the vertical direction, but the present technique is not limited thereto. For example, the first perpendicular portion 92 and the second perpendicular portion 94 may be disposed to extend in an inclination angle larger than 60 degrees with respect to the horizontal direction. According further to the present embodiment, the first horizontal portion 91, the second horizontal portion 93, and the third horizontal portion 95 extend in the horizontal direction, but the present technique is not limited thereto. For example, the first horizontal portion 91, the second horizontal portion 93, and the third horizontal portion 95 may be disposed to extend, in the direction in which toner is conveyed, in the horizontal direction, a downwardly inclined direction, or an upwardly inclined direction at an angle of 15 degrees or less with respect to the horizontal direction.

In a state where the pump 35Y stops after toner T has been conveyed from the toner cartridge CY illustrated in FIG. 18B via the toner conveyance path Q6Y to the developer container 122Y of the process cartridge BY, toner T will remain within the toner conveyance path Q6Y. Specifically, toner T will accumulate at the lower portion of the first perpendicular portion 92 and the second perpendicular portion 94, that is, at the first upward bent portion 96 and the second upward bent portion 98, by gravity. Further, toner T within the first horizontal portion 91, the second horizontal portion 93, and the third horizontal portion 95 will accumulate on the spot.

Next, in a state where the pump 35Y is restarted and air is started to be supplied to the toner conveyance path Q6Y again, air is first supplied to toner T having been accumulated in the first upward bent portion 96. Then, when air and toner T are gradually mixed, bulk density of toner T drops. Next, air is also supplied to toner T accumulated in the second upward bent portion 98, and toner Tis conveyed together with air to the developer container 122Y of the process cartridge BY.

According to the present embodiment, the toner conveyance path Q6Y includes the first upward bent portion 96 and the second upward bent portion 98. The amount of toner T accumulated in the first upward bent portion 96 and the second upward bent portion 98 will be half the amount (V/2) of toner T accumulated in the upward bent portion 84 of the toner conveyance path Q7Y according to the comparative example. The maximum pressure necessary for toner conveyance in the toner conveyance path Q6Y is proportional to the amount of toner T accumulated in one location. Therefore, in the toner conveyance path Q6Y having two upward bent portions 96 and 98 as according to the present embodiment, the maximum pressure necessary for toner conveyance will be pressure (P1/2).

For example, when air is supplied from the pump 35 to the toner cartridge C and the pressure within the first horizontal portion 91 rises to pressure (P1/2), toner T accumulated in the first upward bent portion 96 is conveyed and the pressure within the toner conveyance path Q6Y drops. Then, when air reaches the second upward bent portion 98, the pressure within the second horizontal portion 93 rises again to pressure (P1/2). Thereby, toner T accumulated in the second upward bent portion 98 is conveyed and the pressure within the toner conveyance path Q6Y drops. As described, by disposing a plurality of bent portions (96, 98) on the toner conveyance path Q6Y, toner T accumulated in the bent portion (96, 98) is gradually loosened and conveyed.

Especially according to the present embodiment, two upward bent portions 96 and 98 are disposed such that a height H1 of the toner conveyance path Q6Y is equally divided. In other words, the lengths of the first perpendicular portion 92 and the second perpendicular portion 94 in the vertical direction, i.e., Y direction, are each a length H1/2, which is half the height H1 which is the length of the toner conveyance path Q6Y in the vertical direction. As described, by disposing two upward bent portions 96 and 98 so as to equally divide the height H1 of the toner conveyance path Q6Y, the maximum pressure required for toner conveyance may be reduced further. Thereby, the capacity and size of the pump 35 may be reduced.

The present embodiment has been described based on an example where two upward bent portions 96 and 98 are disposed, but the present technique is not limited thereto. For example, the number of upward bent portions disposed on the toner conveyance path Q6Y may be three or more. By increasing the number of upward bent portions, the amount of toner being accumulated in one upward bent portion may be reduced, and the maximum pressure required for toner conveyance may be reduced further.

Meanwhile, increasing the number of upward bent portions may lead to elongating the toner conveyance path, according to which the pressure losses in the steady state will be increased. Therefore, it is desirable to determine the number of upward bent portions to be within a suitable range according to the performance of the pump 35.

### OTHER EMBODIMENTS

All the embodiments described above have been illustrated based on a configuration of a toner cartridge that may be attached to and detached from the apparatus body 100, but the present disclosure is not limited thereto. The present disclosure is also applicable to an all-in-one cartridge in which the toner cartridge C and the process cartridge B are integrated, or a cartridge in which the toner cartridge C and the developing unit are integrated, according to which similar effects as those described above may be achieved.

In all the embodiments described above, the discharge port 16a and the discharge pipe 27 are disposed on the toner chamber 16, but the present technique is not limited thereto. For example, the discharge port 16a may be disposed on the air chamber 17, the discharge pipe 27 may be formed to pass through a hole formed on the filter 18, the inlet 27a may face the lowest portion 18b of the filter 18, and the outlet 27b may be connected to the discharge port 16a.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159537, filed Sep. 13, 2024, which is hereby incorporated by reference herein in its entirety.

What is claimed is:

1. An image forming apparatus comprising:
a first cartridge configured to accommodate first toner;
a second cartridge configured to accommodate second toner; and
an apparatus body to which the first cartridge and the second cartridge are detachably attached,
wherein the apparatus body includes:
a pump portion configured to discharge air;
a first developer container including a first toner accommodating portion configured to accommodate the first toner;
a second developer container including a second toner accommodating portion configured to accommodate the second toner;
a first tube including a first end communicated with an interior of the first cartridge, and a second end communicated with an interior of the first toner accommodating portion, the first tube being configured to extend from the first end to the second end and to have the first toner pass therethrough; and
a second tube including a third end communicated with an interior of the second cartridge and a fourth end communicated with the interior of the second toner accommodating portion, the second tube being configured to extend from the third end to the fourth end and to have the second toner pass therethrough,
wherein the first cartridge includes:
a first toner chamber configured to accommodate the first toner;
a first filter configured to block passage of the first toner while allowing passage of air;
a first air chamber arranged adjacent to the first toner chamber via the first filter, the first air chamber being provided with a first intake port that takes in air discharged from the pump portion;
a first discharge port configured to discharge the first toner accommodated in the first toner chamber to an exterior of the first cartridge, the first discharge port being connected to the first end of the first tube; and
a first pipe configured to communicate with the first discharge port and through which the first toner discharged from the first discharge port passes, the first toner within the first toner chamber being discharged from the first discharge port and conveyed through the first tube to the first toner accommodating portion by air taken in from the first intake port of the first cartridge,
wherein the second cartridge includes:
a second toner chamber configured to accommodate the second toner;
a second filter configured to block passage of the second toner while allowing passage of air;
a second air chamber arranged adjacent to the second toner chamber via the second filter, the second air chamber being provided with a second intake port that takes in air discharged from the pump portion;
a second discharge port configured to discharge the second toner accommodated in the second toner chamber to an exterior of the second cartridge, the second discharge port being connected to the third end of the second tube; and
a second pipe configured to communicate with the second discharge port and through which the second toner discharged from the second discharge port passes, the second toner within the second toner chamber being discharged from the second discharge port and conveyed through the second tube to the second toner accommodating portion by air taken in from the second intake port of the second cartridge,
wherein a portion, of the first tube, which is longer than half a length from the first end to the second end is configured to extend, in a direction in which the first toner is conveyed, in a horizontal direction, a downwardly inclined direction, or an upwardly inclined direction at an angle of 45 degrees or less with respect to the horizontal direction,
wherein a portion, of the second tube, which is longer than half a length from the third end to the fourth end is configured to extend, in a direction in which the second toner is conveyed, in the horizontal direction, a downwardly inclined direction, or an upwardly inclined direction at an angle of 45 degrees or less with respect to the horizontal direction,
wherein the length from the first end to the second end of the first tube is longer than the length from the third end to the fourth end of the second tube, and
wherein a cross-sectional area of an interior space of the first tube is larger than a cross-sectional area of an interior space of the second tube.

2. The image forming apparatus according to claim 1, wherein the first tube and the second tube are each a cylindrical tube, and
wherein an inner diameter of the first tube is larger than an inner diameter of the second tube.

3. The image forming apparatus according to claim 1, wherein the first tube and the second tube are each a flexible tube having a same inner diameter and which is bendable,
wherein the first tube has a round cross-sectional shape, and
wherein the second tube is deformed to have an elliptical cross-sectional shape.

4. The image forming apparatus according to claim 1, wherein the apparatus body includes a control unit configured to control the pump portion,
wherein the pump portion includes:
a first pump configured to discharge air to be taken into the first intake port of the first air chamber; and
a second pump configured to discharge air to be taken into the second intake port of the second air chamber, and
wherein the control unit is configured to control a drive of the first pump and a drive of the second pump independently.

5. The image forming apparatus according to claim 1, wherein the first discharge port and the first pipe are provided on the first toner chamber,
wherein an end portion, of the first pipe, opposite to an end portion connected to the discharge port is configured to open toward the first filter,
wherein the second discharge port and the second pipe are provided on the second toner chamber, and
wherein an end portion, of the second pipe, opposite to an end portion connected to the discharge port is configured to open toward the second filter.

6. An image forming apparatus comprising:
a first cartridge configured to accommodate first toner;
a second cartridge configured to accommodate second toner; and
an apparatus body to which the first cartridge and the second cartridge detachably attached,
wherein the apparatus body includes:
a pump portion configured to discharge air;
a first developer container including a first toner accommodating portion configured to accommodate the first toner;
a second developer container including a second toner accommodating portion configured to accommodate the second toner;
a first tube including a first end communicated with an interior of the first cartridge, and a second end communicated with an interior of the first toner accommodating portion, the first tube being configured to extend from the first end to the second end and to have the first toner pass therethrough; and
a second tube including a third end communicated with an interior of the second cartridge and a fourth end communicated with the interior of the second toner accommodating portion, the second tube being configured to extend from the third end to the fourth end and to have the second toner pass therethrough,
wherein the first cartridge includes:
a first toner chamber configured to accommodate the first toner;
a first filter configured to block passage of the first toner while allowing passage of air;
a first air chamber arranged adjacent to the first toner chamber via the first filter, the first air chamber being provided with a first intake port that takes in air discharged from the pump portion;
a first discharge port configured to discharge the first toner accommodated in the first toner chamber to an exterior of the first cartridge, the first discharge port being connected to the first end of the first tube; and
a first pipe configured to communicate with the first discharge port and through which the first toner discharged from the first discharge port passes, the first toner within the first toner chamber being discharged from the first discharge port and conveyed through the first tube to the first toner accommodating portion by air taken in from the first intake port of the first cartridge,
wherein the second cartridge includes:
a second toner chamber configured to accommodate the second toner;
a second filter configured to block passage of the second toner while allowing passage of air;
a second air chamber arranged adjacent to the second toner chamber via the second filter, the second air chamber being provided with a second intake port that takes in air discharged from the pump portion;
a second discharge port configured to discharge the second toner accommodated in the second toner chamber to an exterior of the second cartridge, the second discharge port being connected to the third end of the second tube; and
a second pipe configured to communicate with the second discharge port and through which the second toner discharged from the second discharge port passes, the second toner within the second toner chamber being discharged from the second discharge port and conveyed through the second tube to the second toner accommodating portion by air taken in from the second intake port of the second cartridge,
wherein a portion, of the first tube, which is longer than half a length from the first end to the second end is configured to extend, in a direction in which the first toner is conveyed, in an upper direction opposite to a gravity direction, an upwardly inclined direction, or a downwardly inclined direction at an angle of 45 degrees or less with respect to a horizontal direction,
wherein a portion, of the second tube, which is longer than half a length from the third end to the fourth end is configured to extend, in a direction in which the second toner is conveyed, in the upper direction, an upwardly inclined direction, or a downwardly inclined direction at an angle of 45 degrees or less with respect to the horizontal direction,
wherein the length from the first end to the second end of the first tube is longer than the length from the third end to the fourth end of the second tube, and
wherein a cross-sectional area of an interior space of the first tube is smaller than a cross-sectional area of an interior space of the second tube.

7. The image forming apparatus according to claim 6, wherein the first tube and the second tube are each a cylindrical tube, and
wherein an inner diameter of the first tube is smaller than an inner diameter of the second tube.

8. The image forming apparatus according to claim 6, wherein the first tube and the second tube are each a flexible tube having a same inner diameter and which is bendable,
wherein the second tube has a round cross-sectional shape, and
wherein the first tube is deformed to have an elliptical cross-sectional shape.

9. The image forming apparatus according to claim 6, wherein the apparatus body includes a control unit configured to control the pump portion,
wherein the pump portion includes:
a first pump configured to discharge air to be taken into the first intake port of the first air chamber; and
a second pump configured to discharge air to be taken into the second intake port of the second air chamber, and
wherein the control unit is configured to control a drive of the first pump and a drive of the second pump independently.

10. The image forming apparatus according to claim 6, wherein the first discharge port and the first pipe are provided on the first toner chamber,
wherein an end portion, of the first pipe, opposite to an end portion connected to the discharge port is configured to open toward the first filter,
wherein the second discharge port and the second pipe are provided on the second toner chamber, and
wherein an end portion, of the second pipe, opposite to an end portion connected to the discharge port is configured to open toward the second filter.

11. An image forming apparatus comprising:
a first cartridge configured to accommodate first toner;
a second cartridge configured to accommodate second toner; and
an apparatus body to which the first cartridge and the second cartridge are detachably attached,
wherein the apparatus body includes:
a pump portion configured to discharge air;
a first developer container including a first toner accommodating portion configured to accommodate the first toner;
a second developer container including a second toner accommodating portion configured to accommodate the second toner;
a first tube including a first end communicated with an interior of the first cartridge, and a second end communicated with an interior of the first toner accommodating portion, the first tube being configured to extend from the first end to the second end and to have the first toner pass therethrough; and
a second tube including a third end communicated with an interior of the second cartridge and a fourth end communicated with the interior of the second toner accommodating portion, the second tube being configured to extend from the third end to the fourth end and to have the second toner pass therethrough,
wherein the first cartridge includes:
a first toner chamber configured to accommodate the first toner;
a first filter configured to block passage of the first toner while allowing passage of air;
a first air chamber arranged adjacent to the first toner chamber via the first filter, the first air chamber being provided with a first intake port that takes in air discharged from the pump portion;
a first discharge port configured to discharge the first toner accommodated in the first toner chamber to an exterior of the first cartridge, the first discharge port being connected to the first end of the first tube; and
a first pipe configured to communicate with the first discharge port and through which the first toner discharged from the first discharge port passes, the first toner within the first toner chamber being discharged from the first discharge port and conveyed through the first tube to the first toner accommodating portion by air taken in from the first intake port of the first cartridge,
wherein the second cartridge includes:
a second toner chamber configured to accommodate the second toner;
a second filter configured to block passage of the second toner while allowing passage of air;
a second air chamber arranged adjacent to the second toner chamber via the second filter, the second air chamber being provided with a second intake port that takes in air discharged from the pump portion;
a second discharge port configured to discharge the second toner accommodated in the second toner chamber to an exterior of the second cartridge, the second discharge port being connected to the third end of the second tube; and
a second pipe configured to communicate with the second discharge port and through which the second toner discharged from the second discharge port passes, the second toner within the second toner chamber being discharged from the second discharge port and conveyed through the second tube to the second toner accommodating portion by air taken in from the second intake port of the second cartridge, and
wherein an entire length of the first tube is equal to an entire length of the second tube.

12. The image forming apparatus according to claim 11, wherein the first tube and the second tube are each a tube having a same inner diameter.

13. The image forming apparatus according to claim 11, wherein the first developer container extends in a longitudinal direction along a horizontal direction, the first developer container including a first end portion and a second end portion,
wherein the second developer container extends in the longitudinal direction, the second developer container including a third end portion disposed on a same side as the first end portion and a fourth end portion disposed on a same side as the second end portion,
wherein the first tube is arranged to pass the first end portion, in the longitudinal direction, of the first developer container when viewed in a gravity direction, and
wherein the second tube is arranged to pass the fourth end portion, in the longitudinal direction, of the second developer container when viewed in the gravity direction.

14. The image forming apparatus according to claim 11, wherein the first developer container extends in a longitudinal direction along a horizontal direction, the first developer container including a first end portion and a second end portion,
wherein the second developer container extends in the longitudinal direction, the second developer container including a third end portion disposed on a same side as the first end portion and a fourth end portion disposed on a same side as the second end portion,
wherein the first tube is arranged to pass the first end portion, in the longitudinal direction, of the first developer container when viewed in a gravity direction, and
wherein the second tube is arranged to pass the third end portion, in the longitudinal direction, of the second developer container when viewed in the gravity direction.

15. The image forming apparatus according to claim 11, wherein the apparatus body includes a control unit configured to control the pump portion,
wherein the pump portion includes:
a first pump configured to discharge air to be taken into the first intake port of the first air chamber; and
a second pump configured to discharge air to be taken into the second intake port of the second air chamber, and
wherein the control unit is configured to control a drive of the first pump and a drive of the second pump independently.

16. The image forming apparatus according to claim 11, wherein the first discharge port and the first pipe are provided on the first toner chamber,
wherein an end portion, of the first pipe, opposite to an end portion connected to the discharge port is configured to open toward the first filter,
wherein the second discharge port and the second pipe are provided on the second toner chamber, and
wherein an end portion, of the second pipe, opposite to an end portion connected to the discharge port is configured to open toward the second filter.

17. An image forming apparatus comprising:
a cartridge configured to accommodate toner; and
an apparatus body to which the cartridge is detachably attached,
wherein the apparatus body includes:
a pump portion configured to discharge air;
a developer container including a toner accommodating portion configured to accommodate the toner, the developer container being arranged above the cartridge; and
a tube including a first end communicated with an interior of the cartridge, and a second end communicated with an interior of the toner accommodating portion, the tube being configured to extend from the first end to the second end and to have the toner pass therethrough,
wherein the cartridge includes:
a toner chamber configured to accommodate the toner;
a filter configured to block passage of the toner while allowing passage of air;
an air chamber arranged adjacent to the toner chamber via the filter, the air chamber being provided with an intake port that takes in air discharged from the pump portion;
a discharge port configured to discharge the toner accommodated in the toner chamber to an exterior of the cartridge, the discharge port being connected to the first end of the tube; and
a pipe configured to communicate with the discharge port and through which the toner discharged from the discharge port passes, the toner within the toner chamber being discharged from the discharge port and conveyed through the tube to the toner accommodating portion by air taken in from the intake port of the cartridge, and
wherein the tube includes:
a first portion and a second portion that extend, in a direction in which the toner is conveyed, in a vertical direction or a direction at an inclination angle greater than 60 degrees with respect to a horizontal direction between the first end and the second end; and
a third portion that extends in the horizontal direction, a downwardly inclined direction, or an upwardly inclined direction at an angle of 15 degrees or less with respect to the horizontal direction between the first portion and the second portion.

18. The image forming apparatus according to claim 17, wherein a length of the first portion of the tube is shorter than a length of the third portion.

19. The image forming apparatus according to claim 18, wherein a length of the second portion of the tube is shorter than the length of the third portion.

20. The image forming apparatus according to claim 17, wherein the first portion and the second portion extend in the vertical direction.

21. The image forming apparatus according to claim 17, wherein the tube includes:
a fourth portion disposed between the first end and the first portion and configured to extend, in a direction in which the toner is conveyed, in the horizontal direction, a downwardly inclined direction, or in an upwardly inclined direction at an angle of 15 degrees or less with respect to the horizontal direction; and
a fifth portion disposed between the second portion and the second end and configured to extend, in the direction in which the toner is conveyed, in the horizontal direction, or a downwardly inclined direction, or an upwardly inclined direction at an angle of 15 degrees or less with respect to the horizontal direction.

22. The image forming apparatus according to claim 17, wherein a length of the first portion and a length of the second portion in the vertical direction are each half a length of the tube in the vertical direction.
